(19) United States
(12) Patent Application Publication
(10) Pub. No.: US 2014/0153241 A1
(43) Pub. Date: Jun. 5, 2014

(54) DISPLAY BOARD AND DISPLAY BOARD COMPONENTS

(71) Applicant: LSI INDUSTRIES, INC., Cincinnati, OH (US)

(72) Inventor: Andrew Templeton, Quebec (CA)

(73) Assignee: LSI Industries, Inc., Cincinnati, OH (US)

(21) Appl. No.: 13/691,787

(22) Filed: Dec. 1, 2012

(51) Int. Cl. F21V 21/00

(52) U.S. Cl. CPC F21V 21/00
USPC 362/249.02

(57) ABSTRACT

A display board is disclosed for displaying video or still images using light emitting diodes as pixels. The connections of one or more of the light emitting diodes to a carrying circuit board, for example by terminal legs, such that the connections of each light emitting diode are encased in separate pools of potting. Alternatively, each pool of potting could encase the connections of multiple light emitting diodes. The circuit board is associated with a frame and a louver. The louver has a panel and a flange about its perimeter and the flange extends to attach to the frame with a snap-fit attachment. The louver also provides one or more barbs extend from the louver panel through an aperture defined in the circuit board and snap-fits to the frame. The display board also provides a power supply having a power supply case that defines a mounting slot having an insert aperture with a width sized to allow a distal end of a mounting tab extending from the frame to pass through the power supply case. The power supply case further defines a retention slot having a width sized to prevent the frame mounting tab distal end from passing through the base plate.

The present disclosure relates generally to a display board and, more particularly, to the elements and construction of a modular display board. The present disclosure also includes methods of operating a display board as disclosed in patent applications filed in the United States Patent & Trademark Office on Dec. 1, 2012 and entitled “Systems And Methods For Display Board Control”, assigned U.S. Provisional Patent Application No. 61/732,329, and “Systems And Methods For Powering A Display Board”, assigned U.S. Provisional Patent Application No. 61/732,330, both of which are incorporated herein by reference in their entirety.

### FIELD OF THE DISCLOSURE

### Background of the Disclosure

There is a need for improvements of the type described herein for display boards for displaying still images, video, or both.

### SUMMARY OF THE DISCLOSURE

The present disclosure provides a display board and display board components that overcomes deficiencies in prior lighting apparatuses. The display board can be capable of displaying still images and/or video. Use of the terms “video,” “display,” “image” or the like herein is not intended to limit the scope of the disclosure to a board, or components thereof, capable of displaying only still images, only video, or both still images and video. Thus, while various elements of the preferred embodiment may have the term “video” in their name, that term does not preclude use of that embodiment or element with still images.

A display is disclosed comprising: a plurality of modular display blocks, one or more of the modular display blocks comprising a frame defining a perimeter, a circuit board associated with the frame, a plurality of light emitting diodes associated with the circuit board, and a louver; the louver comprising a panel defining a perimeter and one or more apertures, the one or more panel apertures associated with one or more of the plurality of light emitting diodes; and the louver further comprising a flange extending from the panel perimeter to the frame perimeter and attaching the louver to the frame. The louver flange may comprising one or more barbs that facilitate a releasable snap-fit attachment of the louver to the frame. The frame may further comprise a flange defining the perimeter of the frame and the louver flange may further comprise one or more barbs that facilitate a releasable snap-fit attachment of the louver to the frame flange. The frame may further comprise a flange defining the perimeter of the frame and the louver flange may comprise one or more barbs that facilitate a releasable snap-fit attachment of the louver to the frame flange when the barb resides in a recess on the frame perimeter flange. The louver panel may define a plane and the louver flange may extend perpendicular to the plane. One or more bosses may extend from the louver panel to facilitate attachment to the frame. The one or more bosses may extend through an aperture defined in the circuit board to facilitate attachment to the frame. One or more barbs may also extend from the louver panel through an aperture defined in the circuit board to facilitate snap-fit attachment to the frame. The light emitting diodes may each comprising leg terminals mounted to the circuit board surrounded by a pool of potting. The louver may further comprise ribs extending from the louver panel to manage ambient light.

Another display is disclosed comprising: a frame, a circuit board associated with the frame, a plurality of light emitting diodes comprising leg terminals electrically connected to the circuit board, and a louver; the louver comprising a panel defining one or more apertures, the a panel aperture associated with a group of one or more of the plurality of light emitting diodes; and a potting pool covering the leg terminals of only those light emitting diodes in the group. A gasket can be between the louver and the circuit board, the gasket defining an aperture circumscribing the group of light emitting diodes. The aperture can define a perimeter of the potting pool. The gasket comprises a web and a rib extending from the web, the rib circumscribing the group of light emitting diodes. The rib may define a perimeter of the potting pool. The louver panel may further define a perimeter and the louver may comprise a flange extending from the panel perimeter and have one or more barbs that facilitate a snap-fit connection to the louver to the frame. The louver panel may define multiple apertures, each associated with two light emitting diodes. The louver panel may define a plurality of potting pools, one potting pool covering the terminal legs of two light emitting diodes and a second potting pool covering the terminal legs of more or less than two light emitting diodes. One or more bosses may extend from the louver panel to facilitate attachment to the frame. The one or more bosses may extends through an aperture defined in the circuit board to facilitate attachment to the frame. One or more barbs may extend from the louver panel through an aperture defined in the circuit board to facilitate snap-fit attachment to the frame. The circuit board may define a first side, on which the light emitting diodes are attached, a second side comprising electrical components, and the display may have potting on the second side of the circuit board covering connections of one or more of the electrical components to the circuit board. The potting may also cover the entirety of one or more of the electrical components on the second side of the circuit board, or, alternatively, cover the entirety of all of the electrical components on the second side of the circuit board. The display may be comprised of a plurality of modular display blocks, the frame constituting an element of one of the modular display blocks.

Another display is disclosed comprising: a frame, a circuit board associated with the frame, and a plurality of light emitting diodes electrically connected to the circuit board, and a power supply case housing a power supply unit for providing electrical power to the circuit board and light emitting diodes; the frame comprising a mounting tab extending from the frame, the mounting tab comprising a proximate end extending from the frame and a distal end being wider than the proximate end; the power supply case comprising an enclosure body and a base plate, the base plate defining a mounting slot having an insert aperture having a width sized to allow the frame mounting tab distal end to pass through the base plate and a retention slot having a width sized to prevent the frame mounting tab distal end from passing through the base plate wherein the distal end of the mounting tab can be passed through the insert aperture and the power supply case moved to slide the mounting tab into the retention slot. The frame may comprise a plurality of mounting tabs and the power supply case base plate may have a plurality of mounting slots. The frame may comprise four mounting tabs and the power supply case base plate may have four mounting slots. The display and the power supply case may be oriented such that the gravitational pull on the power supply tends to keep the mounting tab in the retention slot of the mounting slot. The proximate end of the mounting tab may comprise an extension arm extending perpendicular to the frame and the distal end of the mounting tab may comprise a holding finger extending perpendicular to the extension arm. The frame may comprise a plurality of perimeter beams and internal braces extending between two or more of the perimeter beams and the mounting tab may extend from one or more of the perimeter beams and internal braces. More specifically, the frame may comprise two horizontal perimeter beams, two vertical perimeter beams connecting the ends of the horizontal perimeter beams, a central internal vertical brace extending between the two horizontal perimeter beams and first and second side internal vertical braces extending between the two horizontal perimeter beams and the mounting tab may extend from one of the central internal vertical brace and the first and second side internal vertical braces. Tabs may extend from the base plate and have a flexible arm extending to a position adjacent to the retention slot such that the flexible arm contacts the distal end of the mounting tab when the mounting tab is in the retention slot. The display may comprise a plurality of modular display blocks with the frame constituting an element of one of the modular display blocks.

Other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology.

### BRIEF DESCRIPTION OF THE DRAWINGS

Aspects and embodiments of the present disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1A is a perspective view of the front side of one embodiment of a video board according to the present disclosure;

FIG. 1B is a perspective view of the rear side of the video board of FIG. 1A;

FIG. 1C is a perspective view of the rear side of a modular cabinet of the video board of FIG. 1A according to the present disclosure with access panels and video blocks removed;

FIG. 1D is the perspective view of the cabinet of FIG. 1C populated with video blocks;

FIG. 1E is a front view of the cabinet of FIG. 1C;

FIG. 2A is a perspective view of the front side of one video block of the video board of FIG. 1A;

FIG. 2B is a perspective view of the rear side of the video block of FIG. 2A, having a power supply case and matrix controller case mounted thereon;

FIG. 2C is a perspective view of the rear side of the video block of FIG. 2A, without a power supply case or matrix controller case;

FIG. 2D is a front view of the video block of FIG. 2A;

FIG. 2E is a rear view of the video block of FIG. 2A, having a power supply case and matrix controller case thereon;

FIG. 2F is an exploded view of select elements of the video block of FIG. 2A;

FIG. 3A is a perspective view of the front side of a frame of the video block of FIG. 2A;

FIG. 3B is a perspective view of the rear side of the vide block frame of FIG. 3A;

FIG. 3C is a rear view of the video block frame of FIG. 3A;

FIG. 3D is a cross-sectional view of the video block of FIG. 2A taken through line 3D-3D of FIG. 2C;

FIG. 3E is a cross-sectional view of the video block of FIG. 2A taken through line 3E-3E of FIG. 2C;

FIG. 3F is an outtake view of the front side of a frame mount nut boss of the frame of the video block of FIG. 2A;

FIG. 3G is a cross-sectional view of the frame mount nut boss of FIG. 3F;

FIG. 3H is an outtake view of the rear side of the frame mount nut boss of FIG. 3F;

FIG. 3I is a cross-sectional view of a PCB mount bolt boss of the frame of FIG. 2A;

FIG. 3J is a cross-sectional view of a PCB stabilizer boss of the frame of FIG. 2A;

FIG. 4 is a front view of the printed circuit board of the video block of FIG. 2A;

FIG. 5A is a perspective view of the front side of the frame gasket of the video block of FIG. 2A;

FIG. 5B is a perspective view of the rear side of the frame gasket of FIG. 5A;

FIG. 6A is a perspective view of the front side of the louver of the video block of FIG. 2A;

FIG. 6B is a perspective view of the rear side of the louver of FIG. 6A;

FIG. 6C is a cross-sectional view of the louver of FIG. 6A taken through lines 6C-6C of FIG. 6A;

FIG. 6D is a close up view of outtake 6D in FIG. 6C;

FIG. 6E is a close up view of the outtake of FIG. 6D when the louver is assembled on the video block of FIG. 2A;

FIG. 6F is an outtake of a louver bolt boss in FIG. 6C;

FIG. 6G is a side view outtake of a portion of the video block of FIG. 2A;

FIG. 6H is a front view outtake of a portion of the video block of FIG. 2D;

FIG. 7A is front view of the louver gasket of the video block of FIG. 2A;

FIG. 7B is a side view of the louver gasket of FIG. 7A;

FIG. 7C is a front view outtake of a portion of the louver gasket of FIG. 7A;

FIG. 8A is an outtake of the front side perspective view of the louver in FIG. 6A;

FIG. 8B is a cross-sectional view taken through the portion of the video block of FIG. 2A as indicated at lines 8B-8B of FIG. 6H;

FIG. 9A is a perspective view of the front side of the power supply case depicted in FIG. 2B;

FIG. 9B is an exploded view of the components of the power supply case of FIG. 9A and a power supply unit housed therein;

FIG. 9C is a perspective view of the rear of the base plate of the power supply case of FIG. 9A;

FIG. 9D is an exploded view showing the power supply case of FIG. 9A detached from the video block of FIG. 2A;

FIG. 9E is a cross-sectional view of the LED block of FIG. 2A taken through lines 9E-9E;

FIG. 10A is a perspective view of the rear side of the matrix controller case of FIG. 2B;

FIG. 10B is a is a perspective view of the front side of the matrix controller case of FIG. 10A;

FIG. 10C is an exploded view showing the matrix controller case of FIG. 10A.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. It is to be understood that the disclosure is intended in an illustrative rather than in a limiting sense, as it is contemplated that modifications will be apparent to those skilled in the art, within the spirit of the invention and the scope of the appended claims. Like components are labeled with identical reference numbers for ease of understanding.

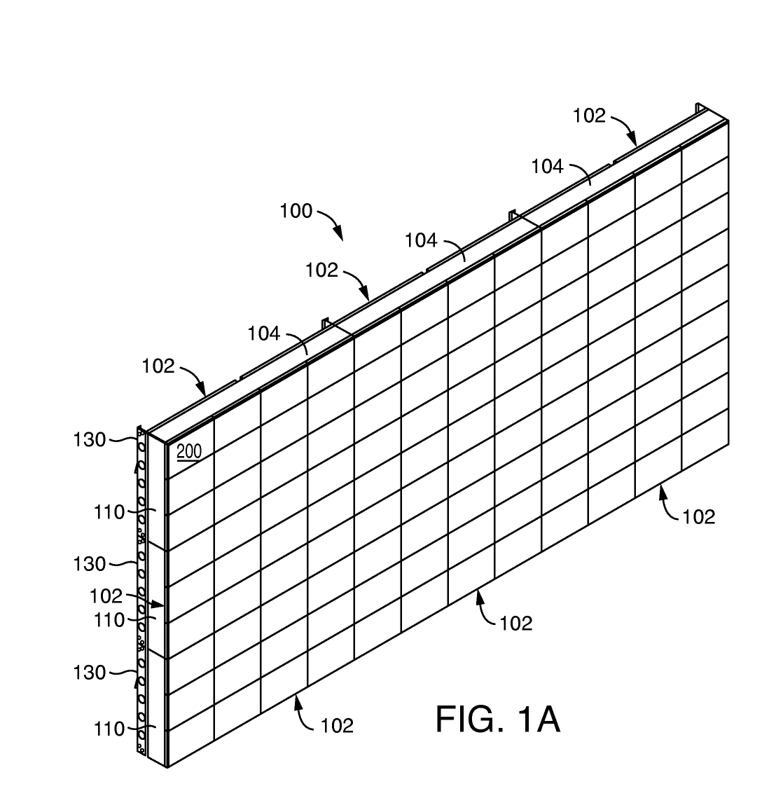

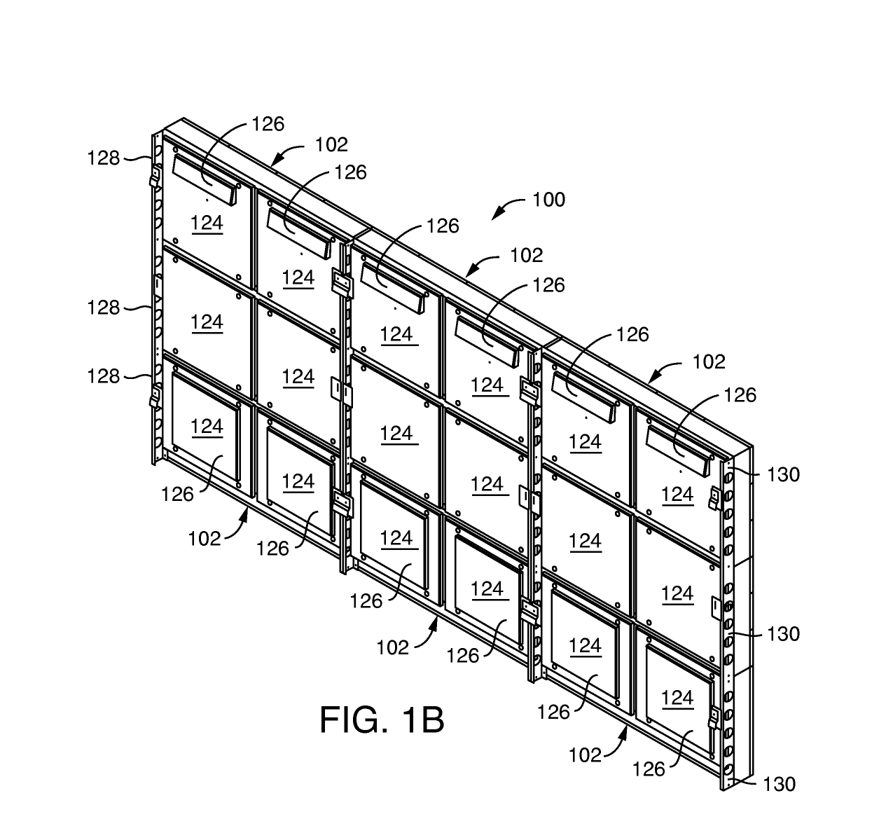

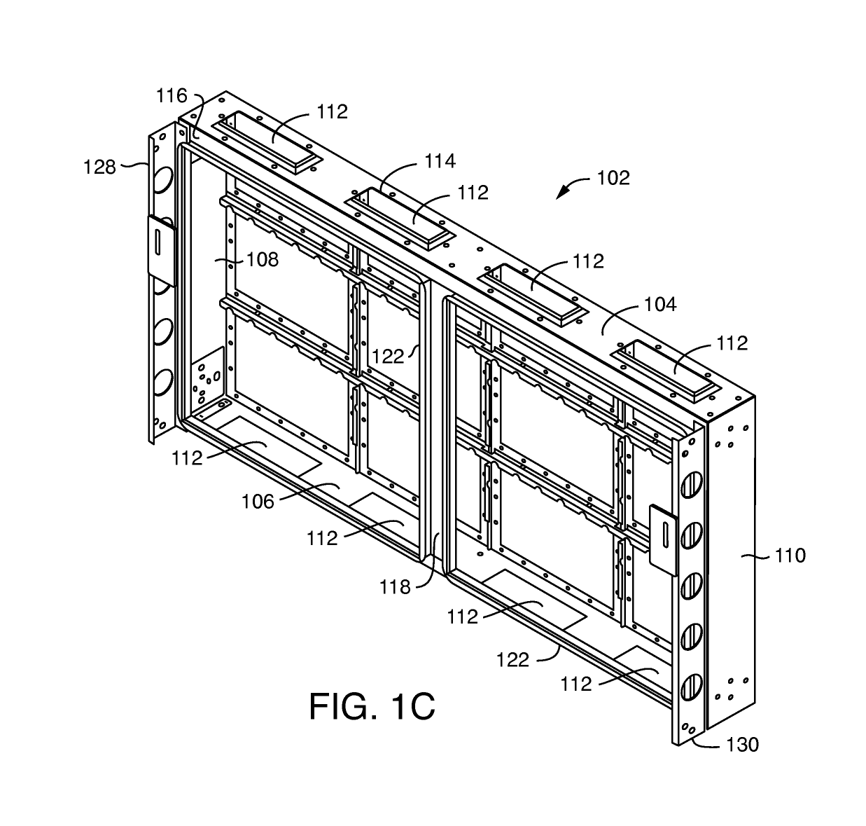

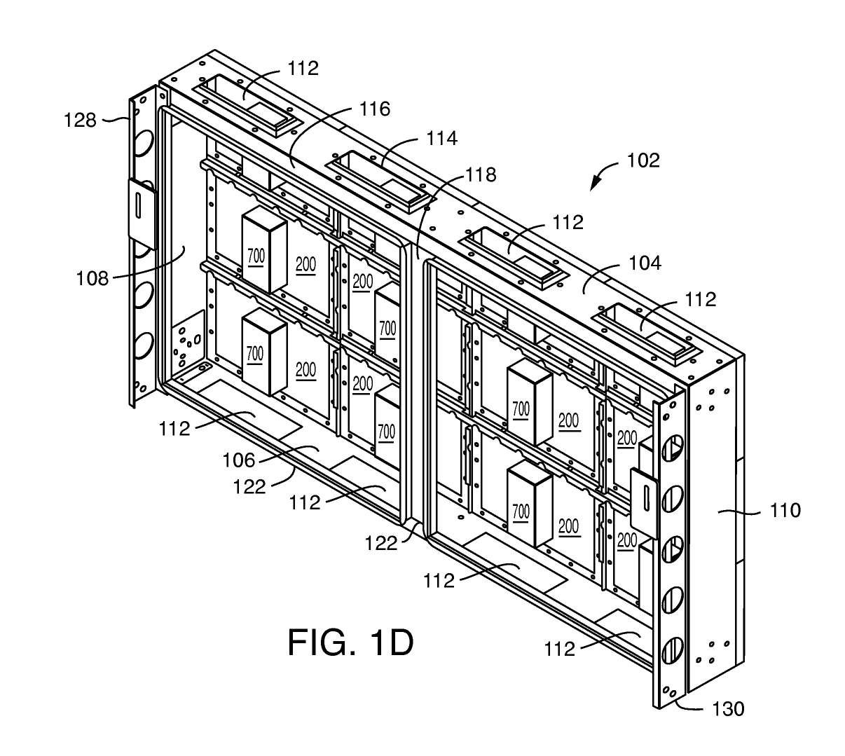

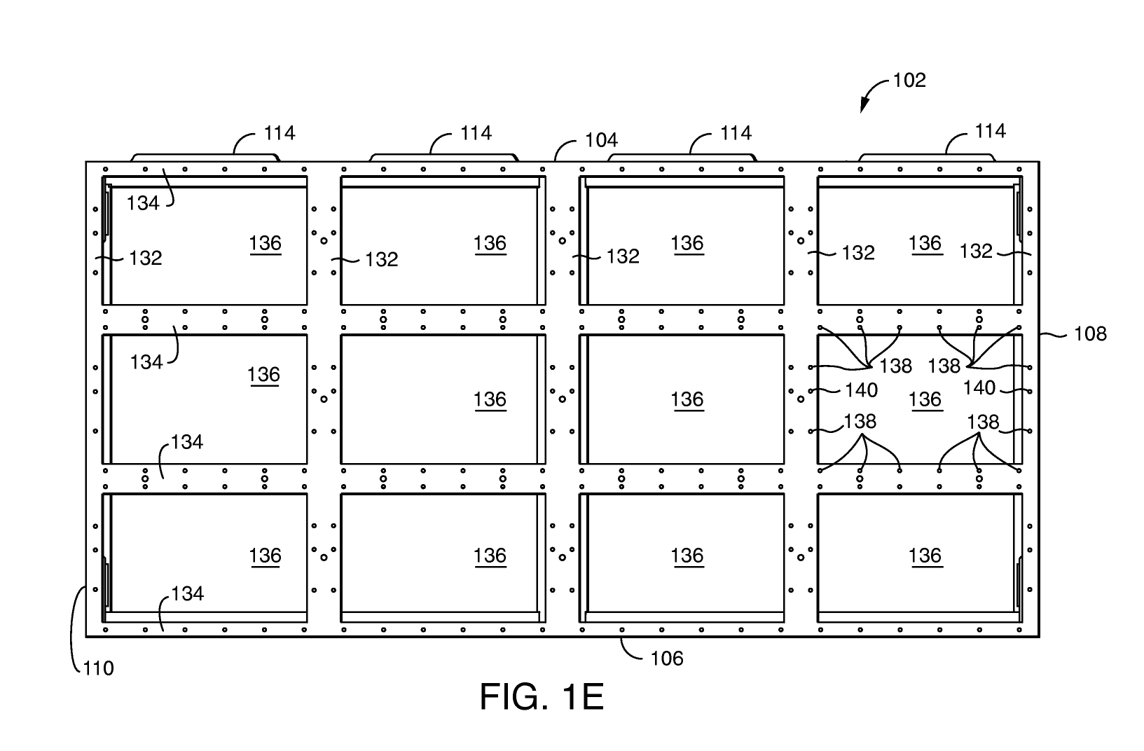

FIGS. 1A and 1B depict an exemplary video board 100 comprised of nine modular cabinets 102, each populated with twelve video blocks 200. As shown in FIGS. 1C, 1D and 1E, each cabinet 102 is comprised of perimeter having an upper perimeter flange 104, lower perimeter flange 106, first side perimeter flange 108 and second side perimeter flange 110. The upper and lower perimeter flanges 104, 106 optionally define apertures 112 to facilitate running wires between cabinets 102 for communication or ventilation between cabinets 102. The lower perimeter flange 106 of those of the cabinets 102 that constitute a lowermost cabinet 120 in the video board 100 do not define apertures 112 in order to protect the inside of the cabinet 102 from the elements. Similarly, the upper perimeter flange 104 of those of the cabinets 102 that constitute an uppermost cabinet 102 in the video board 100 do not define apertures 112 for the same reason. The cabinet 102 depicted in FIGS. 1C, 1D and 1E is cabinet residing between an uppermost and lowermost cabinet in the video board 100 and therefore defines apertures 112 in both the upper and lower perimeter flanges 104, 106. The apertures 112 defined in the upper perimeter flange 104 are defined by a protrusion 114 extending about the perimeter of the defined aperture 112, protruding slightly above the upper perimeter flange 104. These protrusions 114 locate inside the aperture 112 defined in the lower perimeter flange 106 of a cabinet 102 located immediately above and these protrusions 114 assist in properly locating each the cabinets with respect to one another. The protrusions 114 also direct to the outside of the cabinet 102 any water dripping from the aperture 112 defined in the lower perimeter flange 106 of the cabinet 102 located immediately above.

The rear face of the cabinet 102 is comprised of an inwardly directed perimeter flange 116 and a divider beam 118 defining two access openings 120. Each access opening 120 is surrounded by a rearwardly projecting flange 122 extending about the access opening 120. Access panels 124 cover the access openings 120 and may be connected to the cabinet 102 by know means, including screws, bolts, hinges, etc. At least some of the access panels 124 are preferably provided with ventilation shrouding 126 designed to allow inlet and exhaust of air. In one embodiment, each stack of cabinets 102 is open internally by the apertures 112 and air flows through in a chimney-like manner such that air enters ventilation shrouding 126 in the bottom-most cabinets 102 and is exhausted through ventilation shrouding 126 in the upper-most cabinets 102.

Each cabinet 102 further comprises a first mounting beam 128 and a second mounting beam 130, each running vertically along the rearward side of the first side perimeter flange 108 and second side perimeter flange 110, respectively. The mounting beams 128, 130 assist with moving the cabinets 102 and locating the cabinets 102 with respect to each other during assembly of the video board 100. After two cabinets 102 have been aligned one atop the other, the adjacent ends of the first mounting beams 128 may be connected to one another by known means and the adjacent ends of the second mounting beams 130 may be secured to one another by known means. Similarly, when two cabinets 102 have been aligned side-by-side, the adjacent first and second mounting beams 128, 130 may be secured to one another by known means. Additionally, or in the alternative, the cabinets 102 may be connected one to another by their perimeter flanges by bolts or other appropriate means.

The front face of the cabinets 102 comprises vertical beams 132 and horizontal beams 134 defining video block apertures 136 to receive the video blocks 200. The front and rear faces of the cabinet 102 can be formed of sheet metal. The video blocks 200 can be mounted directly to the vertical beams 132 and the horizontal beams 134 of the cabinet front face. Alternatively, the horizontal beams 134 may optionally comprise bracketing to receive the video blocks 200. In the depicted embodiment, the vertical beams 132 and the horizontal beams 134 define mounting holes 138 for receiving bolts to mount the video blocks 200 to the front face of the cabinet 102. Optionally, the beams may also define one or more locator holes 140 to work in conjunction with portions of the video block 200 to locate the video block 200 with respect to the video block aperture 136.

The modular nature of the cabinets 102 facilitate video boards with greater or fewer cabinets 102. Cabinets having greater or fewer video blocks 200 and video blocks 200 arranged in different configurations to constitute a video board are also contemplated. For example, the depicted cabinets 102 accommodate four columns of three video blocks 200. However, other configurations such as three columns of three video blocks 200; two columns of three video blocks 200; three columns of two video blocks 200; four columns of two video blocks 200; two columns of two video blocks 200; and any other combination mechanically supportable are also contemplated. A video board can be comprised of cabinets 102 of all one configuration (except for the ventilation apertures), such as the video board 100 depicted in FIGS. 1A and 1B, or a combination of cabinet configurations to arrive at the size and shape of video board desired. Gasketing and/or other sealing (not depicted) can optionally be incorporated between the cabinets 102 to protect the inside of the cabinet 102 from the elements.

The modular nature of the cabinets 102 allows a video board of any size to be transported from a factory to an installation site as separate cabinets 102. The size of the cabinets facilitates transportation of the cabinets 102 to a desired location on trucks which can pass under bridges and pass along roadways without exceeding size limitations.

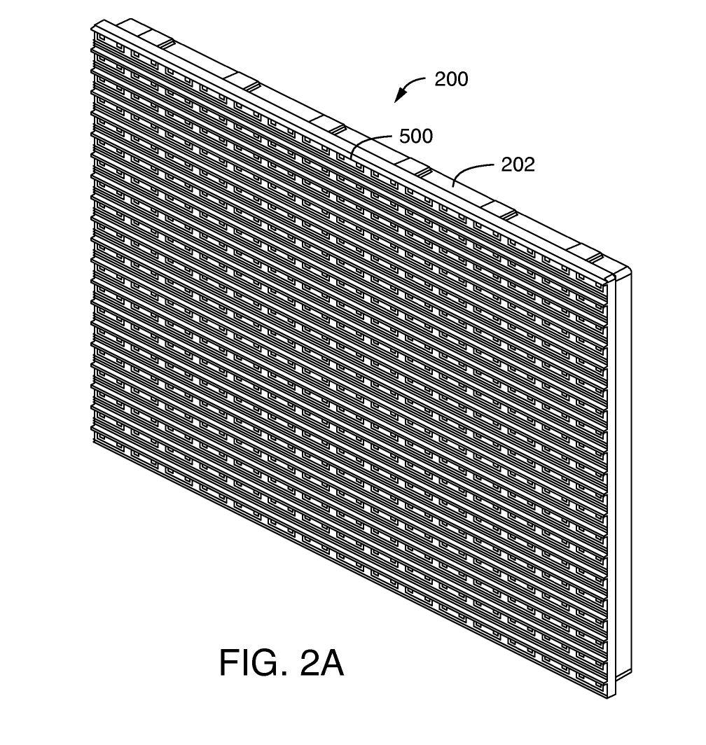

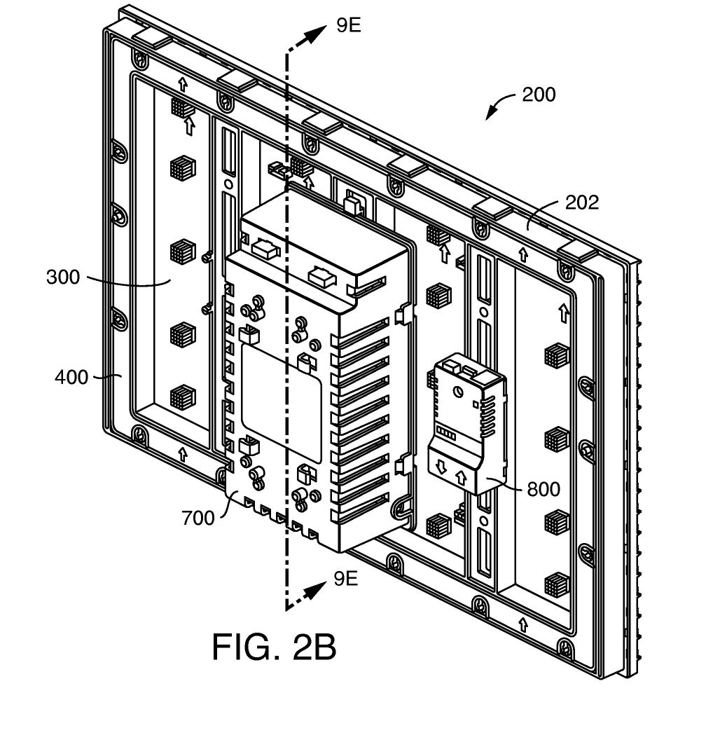

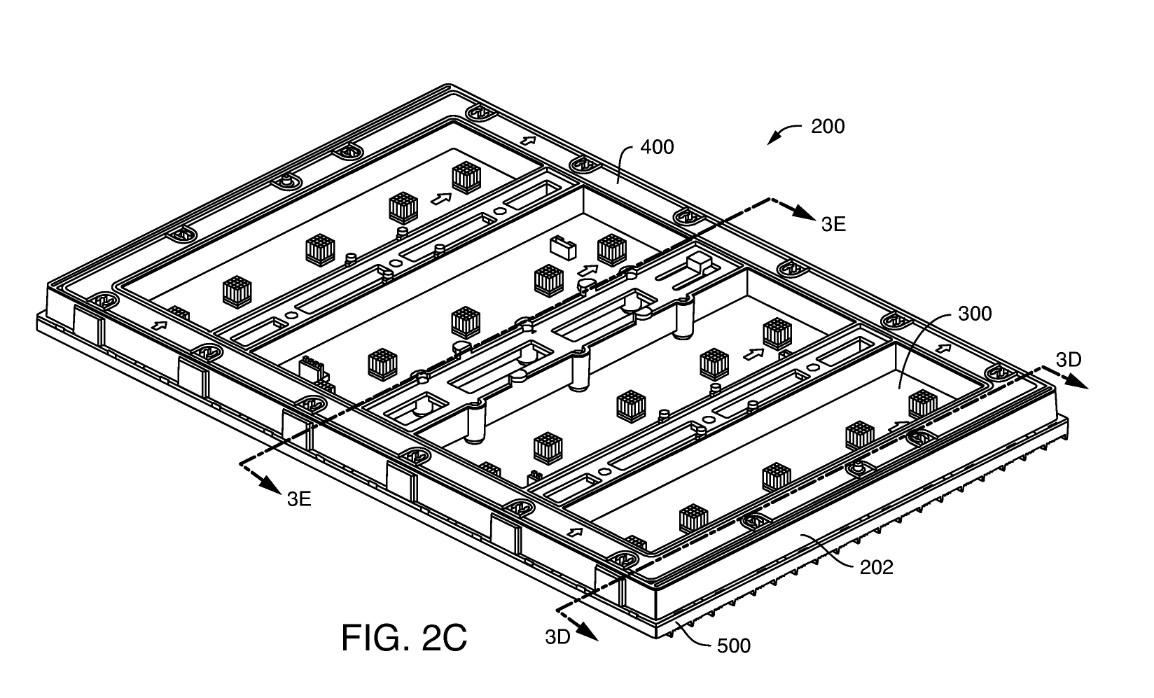

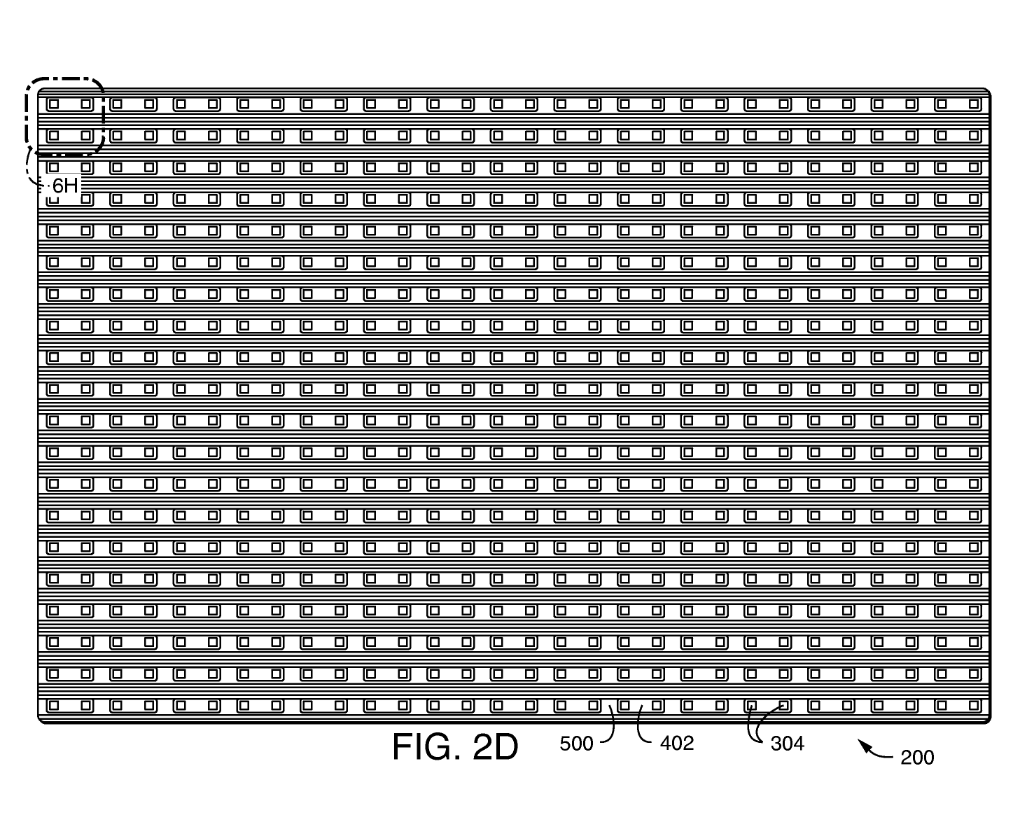

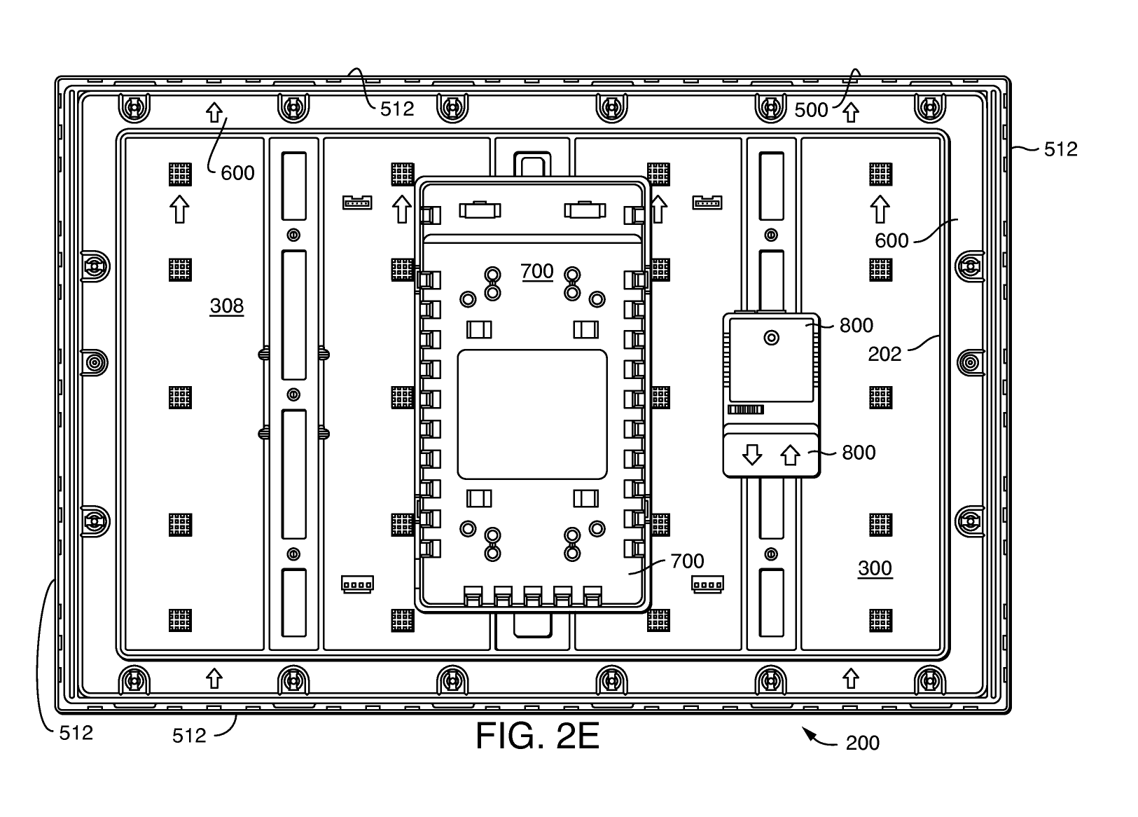

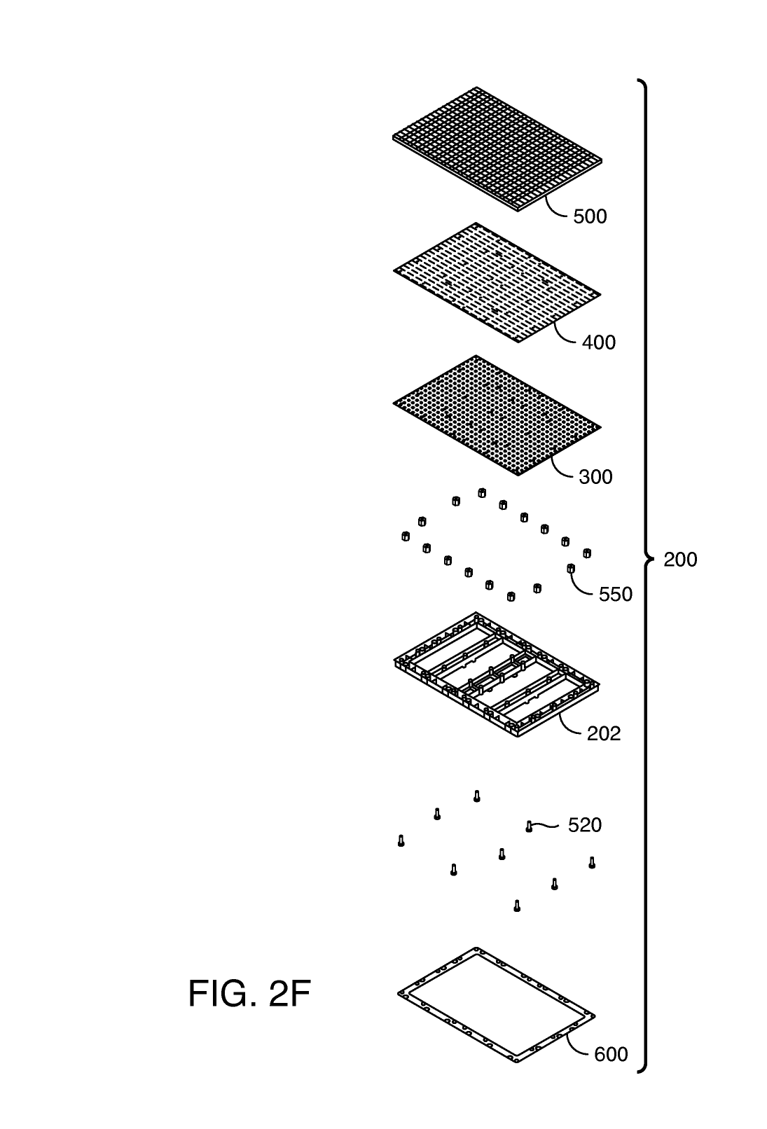

FIGS. 2A and 2B depict perspective views of the front and rear, respectively, of one video block 200. An exploded view of the video block 200 showing its major components is depicted in FIG. 2F which depicts a frame 202, a printed circuit board (“PCB”) 300, a louver gasket 400, a louver 500 and a frame gasket 600. FIG. 2B also depicts a power supply case 700 and a matrix controller case 800 associated with the video block 200.

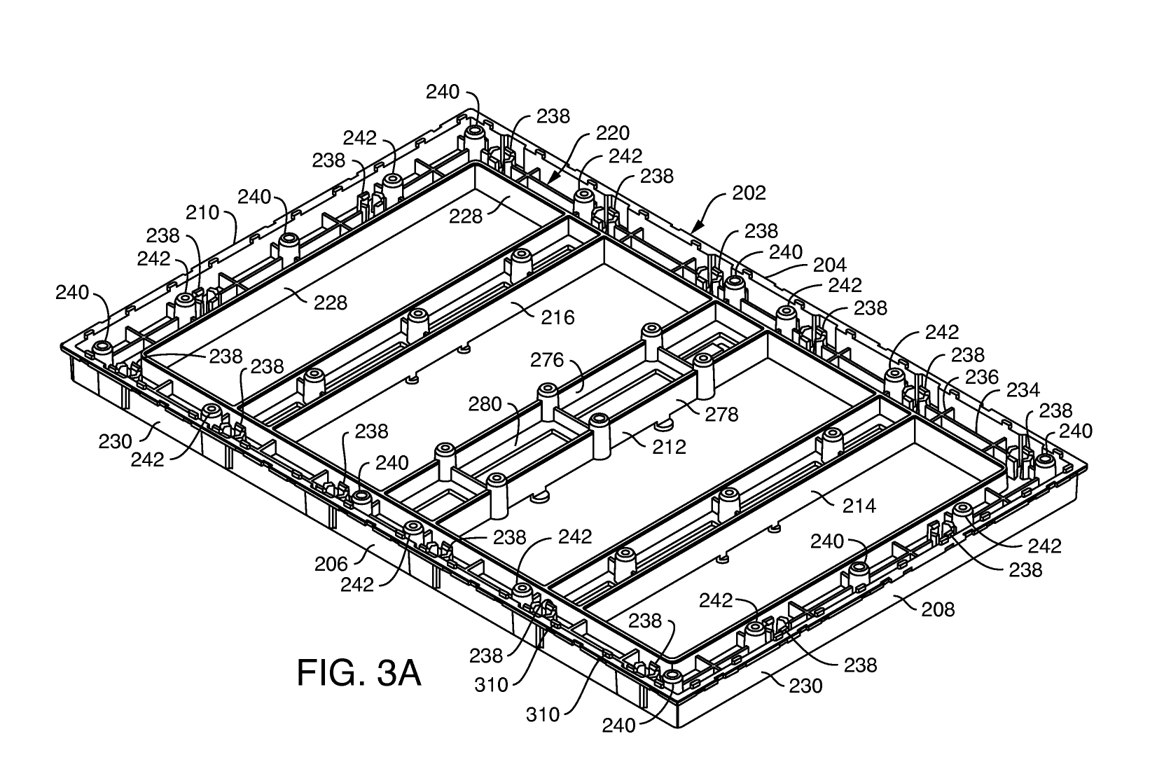

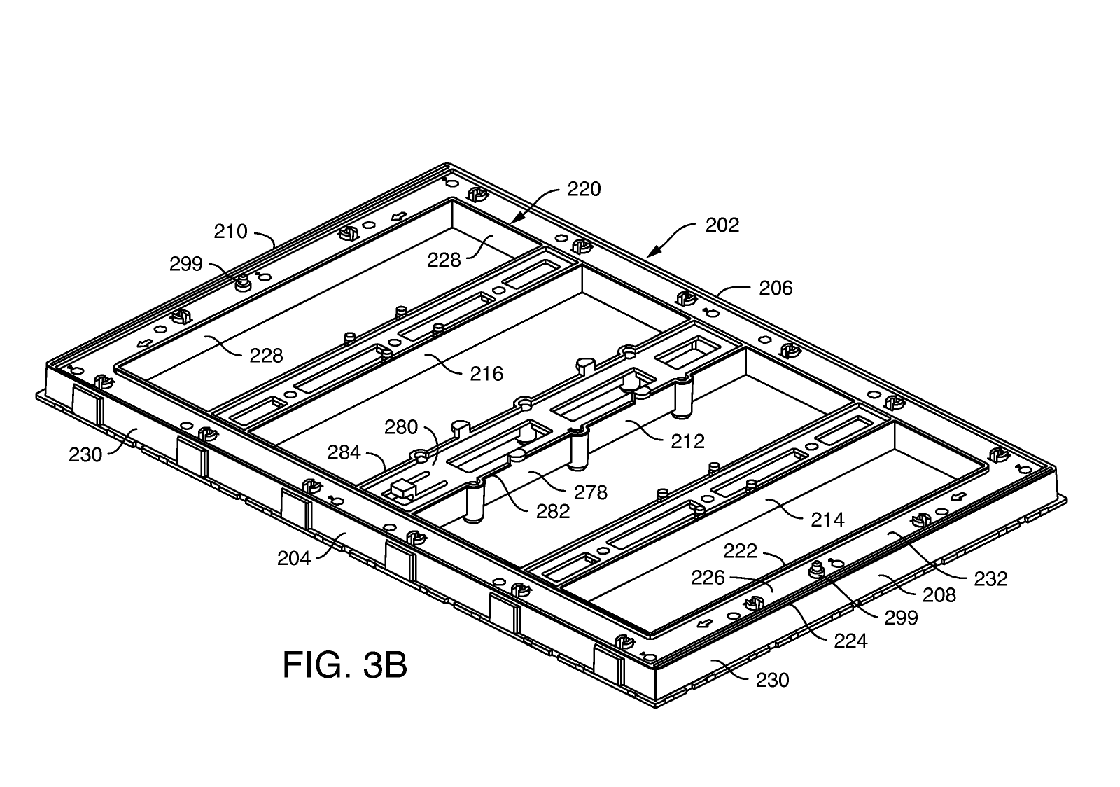

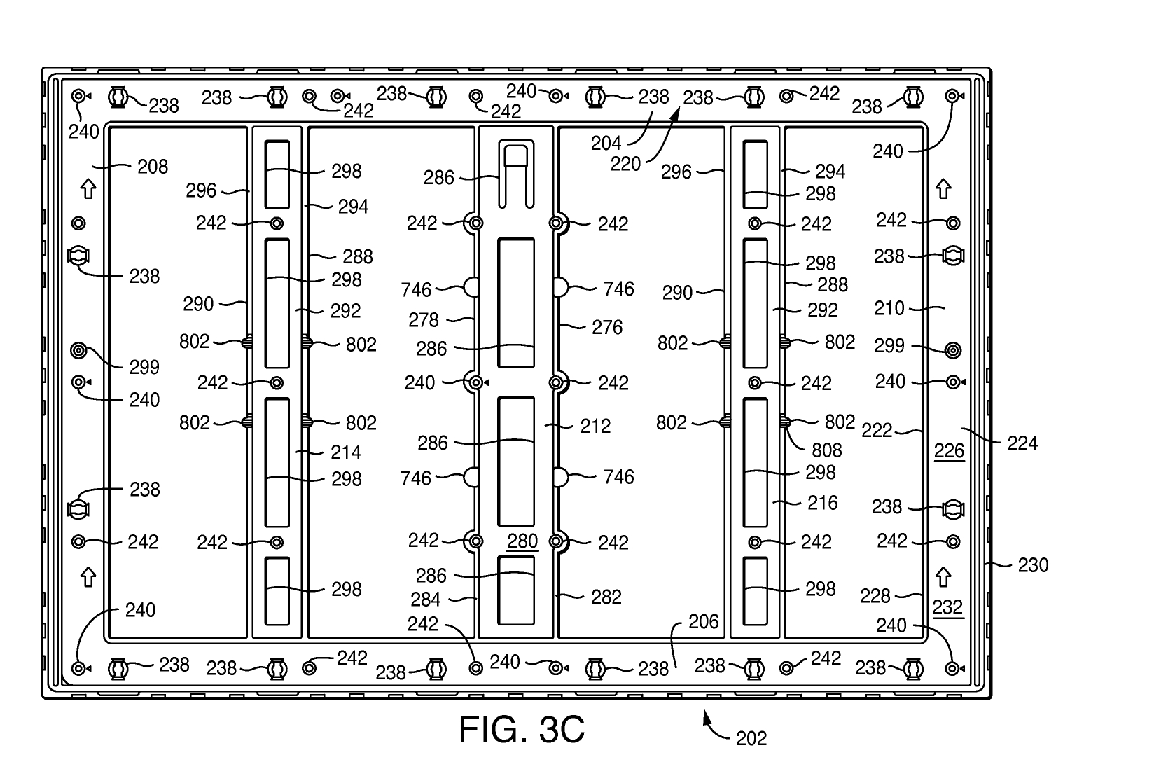

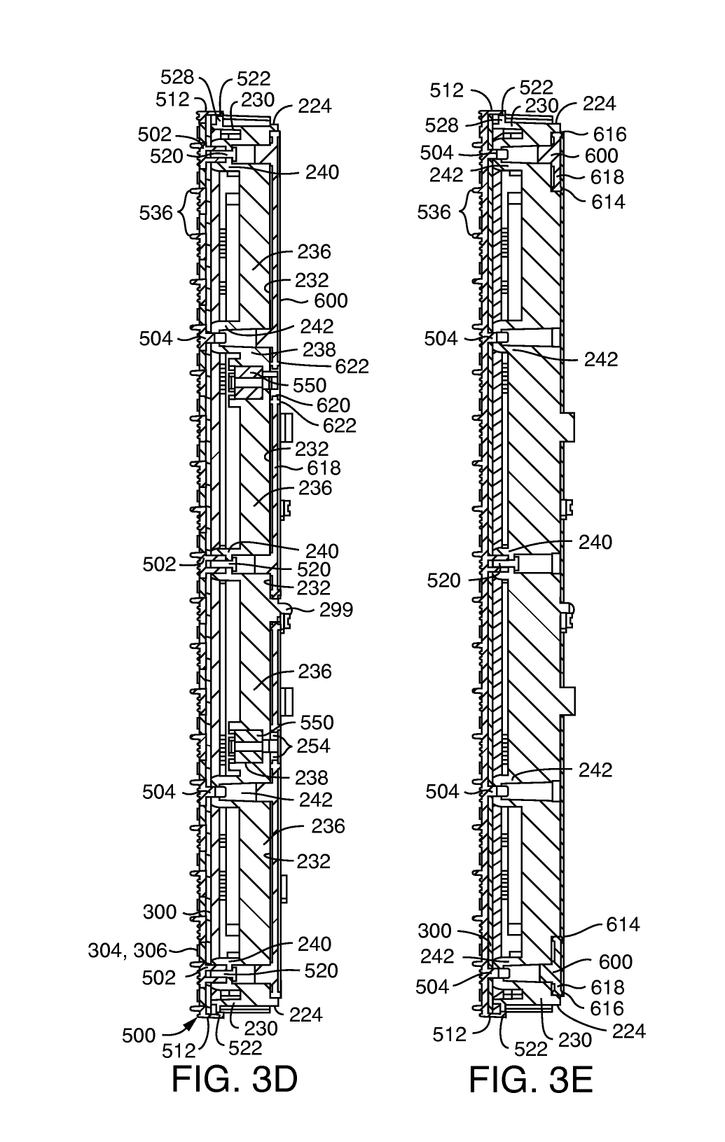

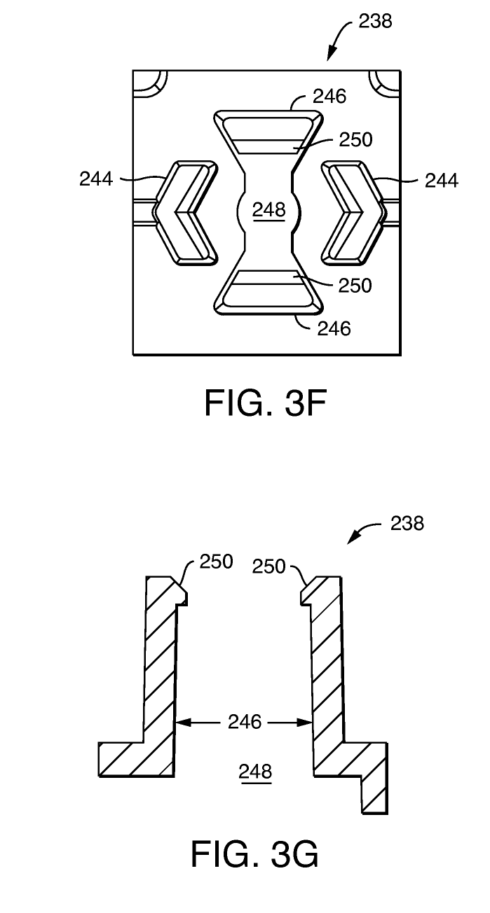

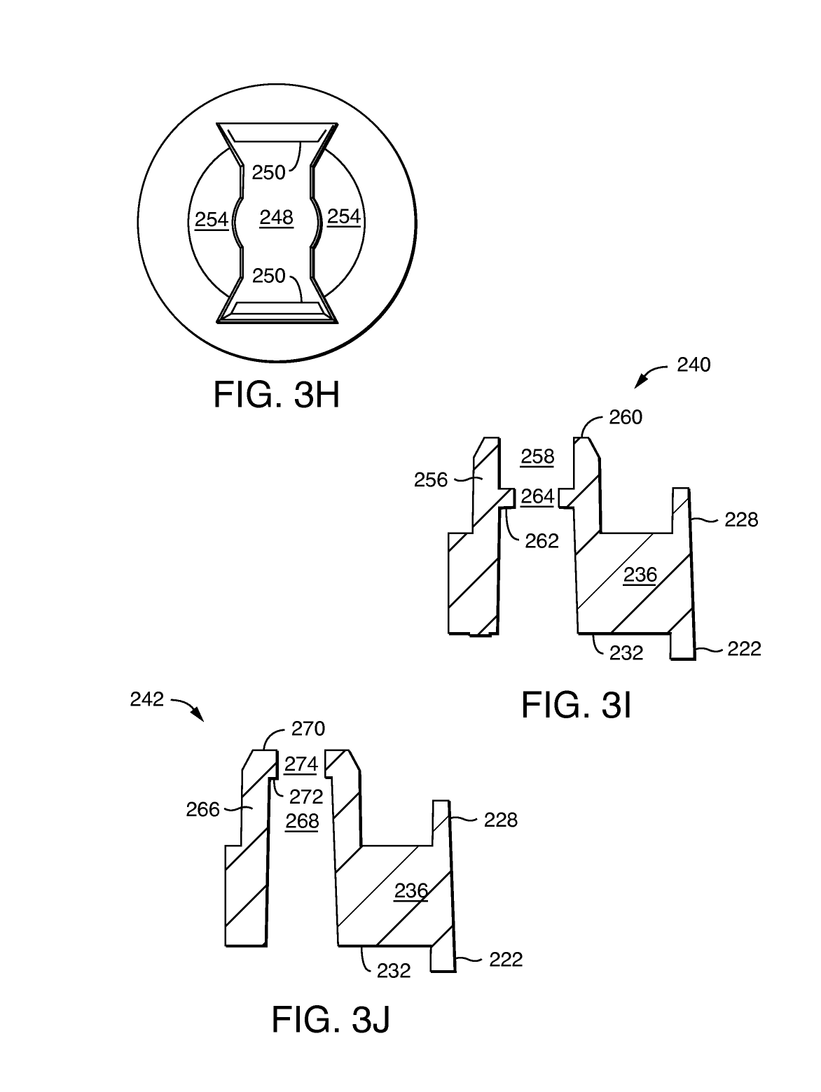

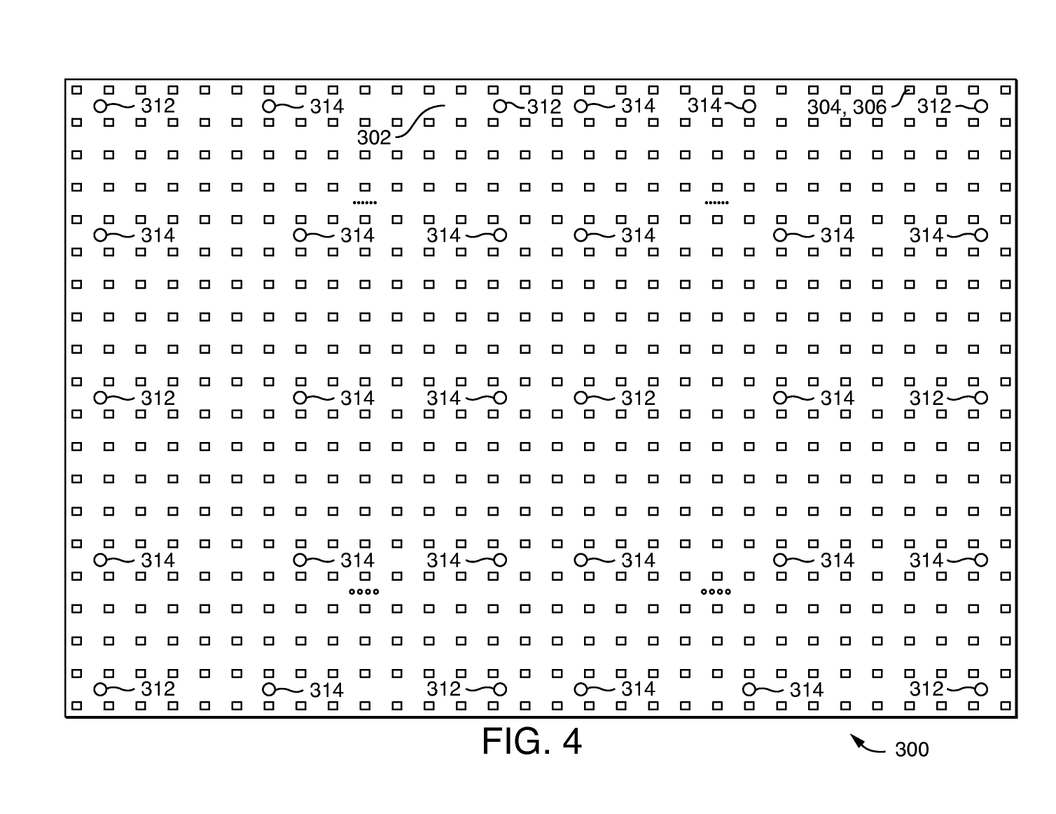

As also depicted in FIGS. 3A-3C, the frame 202 of the video block 200 comprises an upper horizontal perimeter beam 204, a lower horizontal perimeter beam 206, a first vertical perimeter beam 208 extending between the left ends of the upper and lower horizontal perimeter beams 204, 206 and a second vertical perimeter beam 210 extending between the right ends of the upper and lower horizontal perimeter beams 204, 206. The frame 202 also comprises a central vertical brace 212 extending between the upper horizontal perimeter beam 204 and the lower horizontal perimeter beam 206 as well as first and second side internal vertical braces 214, 216 each extending vertically between the upper horizontal perimeter beam 204 and the lower horizontal perimeter beam 206 and located on either side of the central internal vertical brace 212.

The frame 202 defines a front face 218 (depicted in FIG. 3A) and a rear face 220 (depicted in FIG. 3B). An inner channel wall 222 extends from the rear face 220 along the inner perimeter of the upper and lower horizontal perimeter beams 204, 206 and the first and second vertical perimeter beams 214, 216 (sometimes collectively referenced as “the perimeter beams 204, 206, 214, 216”) to define continuous wall. An outer channel wall 224 extends from the rear face 220 along, or close to, the outer perimeter of the perimeter beams 204, 206, 214, 216 to define continuous wall. The inner and outer channel walls 222, 224 define a gasket channel 226 on the rear face 220 of the frame 202. The channel walls 222, 224 need not be continuous. The gasket channel 226 receives the frame gasket 600, as discussed below, to provide a seal between the video block 200 and the vertical and horizontal beams of the cabinet front face 132, 134.

The perimeter beams 204, 206, 214, 216 each comprise an inner perimeter beam wall 228, an outer perimeter beam wall 230 and a rear face wall 232 defining a generally U-shaped channel open to the front face 218 of the frame. The rear face wall 232 defines the base of the gasket channel 226 and a portion of the rear face 220 of the frame 202. The generally U-shaped channel defined by the perimeter beams 204, 206, 214, 216 comprises a first perimeter beam rib 234 extending from the rear face wall 232 toward the front face 218 of the frame 202 and extending along the entirety of the perimeter beams 204, 206, 214, 216 to form a rectangular rib. The generally U-shaped channel defined by each of the perimeter beams 204, 206, 214, 216 further comprises a plurality of transverse perimeter beam ribs 236 extending from the rear face wall 232 toward the front face 218 of the frame 202 and extending between the inner and outer perimeter beam walls 228, 230, transverse to, and connected with, the first perimeter beam rib 234. The combination of the first perimeter beam rib and the transverse perimeter beam ribs maximizes the strength of the perimeter beams 204, 206, 214, 216 while minimizing the material use and weight of the frame.

The frame 202 further comprises several frame mount nut bosses 238, PCB mount bolt bosses 240 and PCB stabilizer bosses 242. The term “bolt” as used herein (including in the name of elements such as the PCB mount bolt boss 240) is meant to include bolts, screws and the like. The frame mount nut bosses 238 are depicted in FIGS. 3A, and 3F-3H. Each frame mount nut boss 238 is comprised of two guide arms 244 and two retention arms 246, all extending from the rear face wall 232 of the perimeter beams 204, 206, 214, 216 toward the front face 218 of the frame 202. The proximal ends of the guide arms 244 and retention arms 246 define a bolt aperture 248 through the rear face wall 232 to receive a bolt to secure the frame 202 to an associated cabinet 102. As depicted in FIG. 3F, the two guide arms 244 are generally V-shaped in cross-section. This V-shape allows the guide arms 244 to receive corners of nut (such as frame mount insert nuts 550) and prevent the nut from rotating as an associated bolt is turned to tighten the frame 202 to the cabinet 102. The two retention arms 246 are flat in cross-section, and extend to a snap-fit retention barb 250 at the distal end, as best depicted in FIG. 3G. The snap-fit retention barbs 250 each have an angled downward and inward face 252 from the front face 218 toward the rear face 220. This downward and inward angled face 252 forces the distal ends of the retention arms 246 to bend outward when a nut (e.g. nut 550) is pressed into the frame mount nut boss 238 from the front face 218 of the frame 202 until the nut is completely within the frame mount nut boss 238 and the distal end of the retention arms 246 snap back and the retention barbs 250 prevent the nut from escaping the frame mount nut boss 238 without again deforming the retention arms 246.

About each bolt aperture, two stabilizers 254 extend rearward from the rear face wall 232 of the perimeter beams 204, 206, 214, 216 to the height of the inner and outer channel walls 222, 224. In this configuration, the stabilizers will meet (or almost meet, depending on the thickness of the frame gasket 600) the cabinet 202 and prevent deformation of the rear face wall 232 as a nut is tightened to the cabinet by a bolt. The stabilizers 254 are depicted as generally semicircular in shape, but other shapes are contemplated. The relative sizes and shapes of the elements of the frame mount nut boss 238 may vary as needed to accommodate the size and shape of nut used.

Each PCB mount bolt boss 240 extends from a proximate end at the rear face wall 232 of the perimeter beams 204, 206, 214, 216 toward the front face 218 of the frame 202 to a distal end and comprises a cylindrical wall 256 defining a bolt aperture 258 in the center thereof which extends through the rear face wall 232. The distal ends of the cylindrical wall 256 defines a flat 260 for contacting the PCB 300. A bolt catch wall 262 projects inwardly from the cylindrical wall 256 between the proximate and distal ends to define a narrowed bolt aperture 264. A bolt (or screw or other connection mechanism) extends through the narrowed bolt aperture 264 from the rear face 220 of the frame 202 and connects to a corresponding connection mechanism of the louver 500, described below, such that the head of the bolt is captured by the bolt catch wall 262 and pulls the louver 500 to the frame 202 as the bolt is tightened.

Each PCB stabilizer boss 242 extends from a proximate end at the rear face wall 232 of the perimeter beams 204, 206, 214, 216 toward the front face 218 of the frame 202 to a distal end and comprises a cylindrical wall 266 defining a cylindrical aperture 268 in the center thereof which extends through the rear face wall 232. The distal ends of the cylindrical wall 266 defines a flat 270 for contacting the PCB 300. The distal end of the cylindrical wall 266 further defines an inwardly projecting wall 272 defining a narrowed entry aperture 274. During assembly, the narrowed entry aperture 274 receives a snap-fit connector from the louver 500 (described below) which expands and becomes locked inside the cylindrical aperture 268 when pressed fully inside the stabilizer boss 242. This snap fit connection between the louver 500 and the frame 202 works in conjunction with the bolted connection provided by the PCB mount bolt bosses 240 to secure the louver 500 to the frame 202 and keep the PCB 300 secure therebetween. When the snap fit connection between the louver 500 and the frame 202 is fully engaged, the flat 270 is firm again the PCB 300. The flats 260 of the PCB mount bolt bosses 240 and the flats 270 of the PCB stabilizer bosses 270 minimize or eliminate movement of the PCB 300 with respect to the remainder of the frame 202 due to vibration or the like.

Although the disclosed embodiment uses both PCB mount bolt bosses 240 and PCB stabilizer bosses 270, it is contemplated that either one would, on its own, sufficiently secure the louver 500 to the frame 202. However, maximizing the number of PCB stabilizer bosses 242 and minimizing the number of PCB mount bolt bosses 240 will increase assembly efficiencies by taking advantage of the snap-fit nature of the PCB stabilizer bosses 270 and minimizing screwing time required by the PCB mount bolt bosses 240. Different sizes and numbers of the PCB mount bolt bosses 240 and PCB stabilizer bosses 270 are contemplated based on the size and weight of the frame 202, PCB 300 and louver 500. Further, the depicted embodiment locates each of the frame mount nut bosses 238, the PCB mount bolt bosses 240 and the PCB stabilizer bosses 242 of the perimeter beams 204, 206, 214, 216 along the first perimeter beam rib 234 to provide them with additional stability.

The central internal vertical brace 212 extends from the inner perimeter beam wall 228 of the upper horizontal perimeter beam 204 to the inner perimeter beam wall 228 of the lower horizontal perimeter beam 206. The central internal vertical brace 212 comprises a first brace wall 276, a second brace wall 278, both running from the frame front face 218 to the frame rear face 220, and a rear face wall 280 and configured to define a generally U-shaped brace open to the frame front face 218. The rear face wall 280 is parallel to the rear face 220 and in the same plane as a plane formed by the rear face wall of the perimeter breams 232, which is recessed from the outermost reach of the inner channel wall 222 of the upper horizontal perimeter beam 204 and lower horizontal perimeter beam 206. First and second channel walls 282, 284 extend along the sides of the central internal vertical brace 212 from the rear face wall 280 rearward to the same height as the inner channel wall 222. The rear face wall 280 of the central internal vertical brace 212 defines four ventilation holes 286 to permit air flow there through and avoid creating zones of stagnant air on or adjacent to the PCB 300 adjacent to the central vertical brace 212.

The central internal vertical brace 212 can comprise one or more of the PCB mount bolt bosses 240 and/or the PCB stabilizer bosses 242. In the depicted embodiment, the central internal vertical brace 212 comprises three PCB stabilizer bosses 242 in the first brace wall 276, two PCB stabilizer bosses 242 in the second brace wall 276 and one PCB mount bolt boss 240 in the second brace wall 276. Use of PCB mount bolt bosses 240 and/or the PCB stabilizer bosses 242 on the central internal vertical brace 212 further stabilizes the PCB 300 and the louver 500.

The first side internal vertical brace 214 and second side internal vertical brace 216 (collectively “internal vertical braces 214, 216”) extend from the inner perimeter beam wall 228 of the upper horizontal perimeter beam 204 to the inner perimeter beam wall 228 of the lower horizontal perimeter beam 206. The internal vertical braces 214, 216 comprise a first brace wall 288, a second brace wall 290, both running from the frame front face 218 to the frame rear face 220, and a rear face wall 292 and configured to define a generally U-shaped brace open to the frame front face 218. The rear face wall 292 is parallel to the rear face 220 and in the same plane as a plane formed by the rear face wall 232 of the perimeter beams 204, 206, 214, 216, which is recessed from the outermost reach of the inner channel wall 222 of the upper horizontal perimeter beam 204 and lower horizontal perimeter beam 206. First and second channel walls 294, 296 extend along the sides of the internal vertical braces 214, 216 from the rear face wall 292 rearward to the same height as the inner channel wall 222. The rear face walls 292 of the internal vertical braces 214, 216 each define four ventilation holes 298 to permit air flow there through and avoid creating zones of stagnant air on or adjacent to the PCB 300 adjacent to the internal vertical braces 214, 216.

The internal vertical braces 214, 216 can comprise one or more of the PCB mount bolt bosses 240 and/or the PCB stabilizer bosses 242. In the depicted embodiment, the internal vertical braces 214, 216 each comprise three PCB stabilizer bosses 242 extending from the rear face wall 292. Fewer or more PCB stabilizer bosses 242 could be used. PCB mount bolt bosses 240 could be substituted for one or more PCB stabilizer bosses 242. Use of PCB mount bolt bosses 240 and/or the PCB stabilizer bosses 242 on the internal vertical braces 214, 216 further stabilizes the PCB board 300 and louver 500.

A locator prong 299 extends rearward from the rear face wall 232 of the first vertical perimeter beam 208 of the frame 202. Another locator prong 299 extends rearward from the rear face wall 232 of the second vertical perimeter beam 210 of the frame 202. In the depicted embodiment, these locator prongs 299 are cylindrical pins with a rounded distal end extending perpendicular to the rear face wall 232. These locator prongs 299 assist an assembler with locating the video block 200 properly on an associated cabinet 102 by aligning the locator prongs 299 with associated locator holes 140 on the cabinet face vertical beams 132. Fewer or more locator prongs and associated locator holes may be used and/or located in different locations on the cabinet face vertical beams 132, or on the horizontal beams 134, or elsewhere.

In one exemplary embodiment, the frame 202 is injection molded as a single piece from a polymer capable of supplying sufficient strength and rigidity. Other materials and construction techniques are also within the disclosed invention.

The PCB 300 comprises a front face 302 populated with light emitting diodes (“LEDs”) 304. Other light sources are also contemplated. The LEDs 304 may be organized in any manner or pattern. In the depicted embodiment, the LEDs 304 are arranged in a matrix having twenty rows 306 of LEDs 304, each row 306 comprised of thirty LEDs 304 to constitute a total of six hundred LEDs 304 on the PCB 300. In each row 306, the LEDs 304 are spaced evenly from each other a predetermined distance and each row 306 is spaced that same distance from each adjacent row 306. As a result, the LEDs 304 are all evenly spaced from each adjacent LED 304. Each LED 304 constitutes a pixel 306 of the video board 100.

Each pixel 306 preferably comprises a red light source, a green light source and a blue light source to provide each pixel 306 with RGB capability allowing mixture of the red, green and blue lights to cause the pixel 306 to emit any desired light color. Preferably, this is accomplished with a red LED, a green LED and a blue LED. In a preferred embodiment, the red, green and blue LEDs 304 are provided in a single chip such that each pixel 306 can comprise a single LED 304. The depicted LEDs 304, for example, is comprised of three LEDs, a red LED, a green LED, and a blue LED. In one exemplary embodiment, the LEDs 304 are Nichia NSSM032T. Alternatively, separate red, green and blue LEDs can be used for each pixel 306. Other known LEDs and types of LEDs (e.g. organic LEDs “OLED”s) are also contemplated.

The PCB 300 comprises a rear face 308. The rear face 308 comprises various exposed electrical components (not depicted) which are exposed to ambient air and elements such as moisture which can cause environmental degradation to the electrical components. This degradation can reduce efficiency and, ultimately, cause failure. Even when assembled in a video board 100, the rear face 308, and its electrical components, could be subjected to heat, cold, humidity and, perhaps, even water if the video board 100 is located outdoors. Similarly, the LEDs 304 on the front face 302 of the PCB and the connections between the LEDs 304 and the PCB 300 are subjected to environmental degradation. To reduce this environmental degradation, the rear face 308 and portions of the front face 302 are coated in potting, discussed below, to keep moisture (including humidity) away from the electrical components, or portions thereof, on the rear face 308 of the PCB 300 and the connections between the LEDs 304 and the PCB 300 on the front face 302 of the PCB 300.

A plurality of spacer nubs 310 extend forward of the front face 218 of the outer perimeter beam wall 230 on each of the upper and lower horizontal perimeter beams 204, 206 and the first and second vertical perimeter beams 208, 210. The spacer nubs 310 space the PCB from the frame front face 218 to allow proper flow of potting over the PCB rear face 308. In an exemplary embodiment, the spacer nubs 310 are spaced from one another, center to center, approximately 1.25 to 1.5 inches and extend roughly 0.0625 inches from the frame front face 218. However other spacing and dimensions of the spacer nubs 310 are contemplated depending on, for example, the size, thickness and flexibility of the PCB, the viscosity of the potting or other circumstances in order to provide appropriate spacing to allow proper flow of the potting.

The PCB 300 defines louver bolt boss apertures 312 to receive louver bolt bosses 502 there through, as discussed further below. The PCB 300 further defines louver snap-fit prong apertures 314 to receive louver snap-fit prongs 504, as discussed further below.

The louver 500 defines a front face 506 and a rear face 508. The louver 500 is comprised of a video panel 510 and a louver flange 512 extending rearward of the video panel 510. In the exemplary embodiment, the louver flange 512 extends about the entire perimeter video panel 510. The video panel defines a plurality of LED apertures 514 which circumscribe one or more LEDs 304 on the PCB 300. In the exemplary embodiment, each LED aperture 514 circumscribes a pair of LEDs 304. Alternatively, LED apertures could circumscribe greater or fewer LEDs 304 and may vary across the video panel 510 in the number of LEDs 304 circumscribed. The LED apertures 514 in the exemplary embodiment are configured in a matrix of aligned rows and columns.

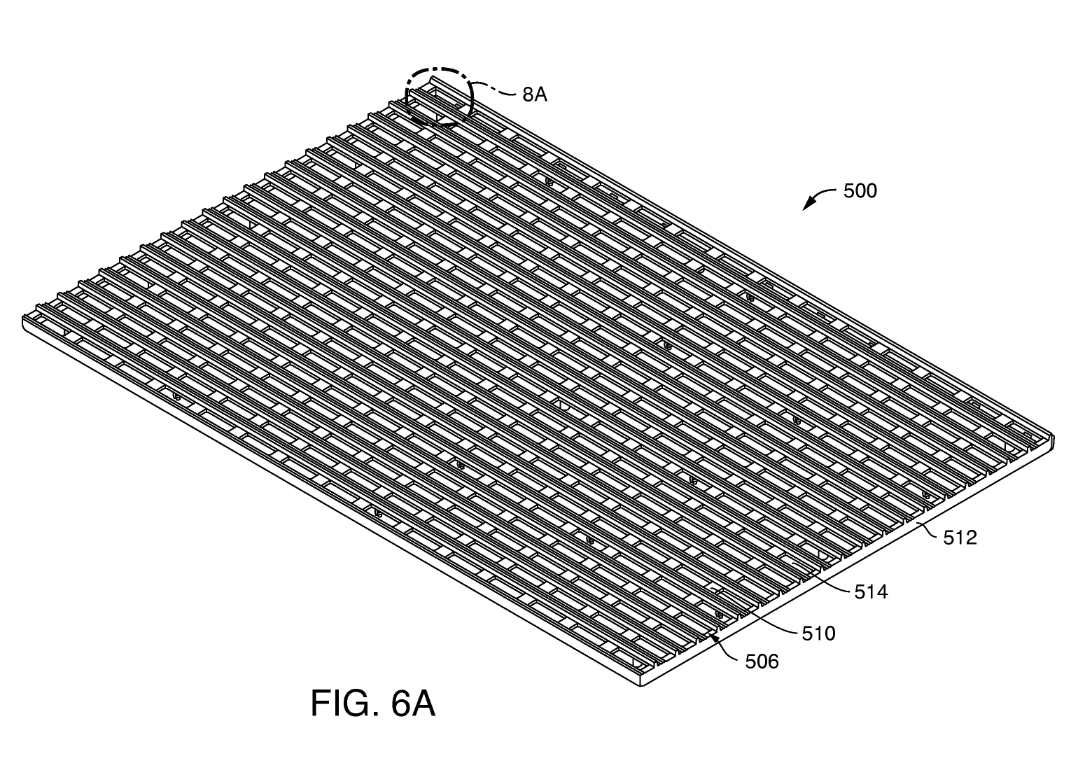

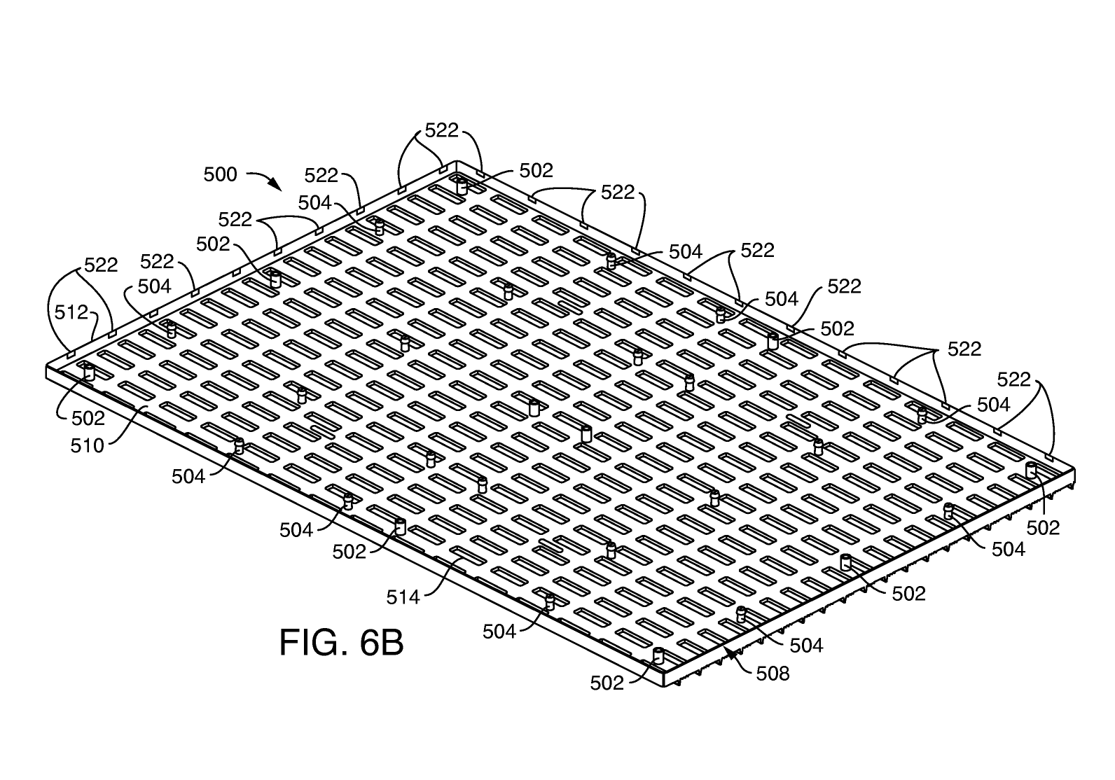

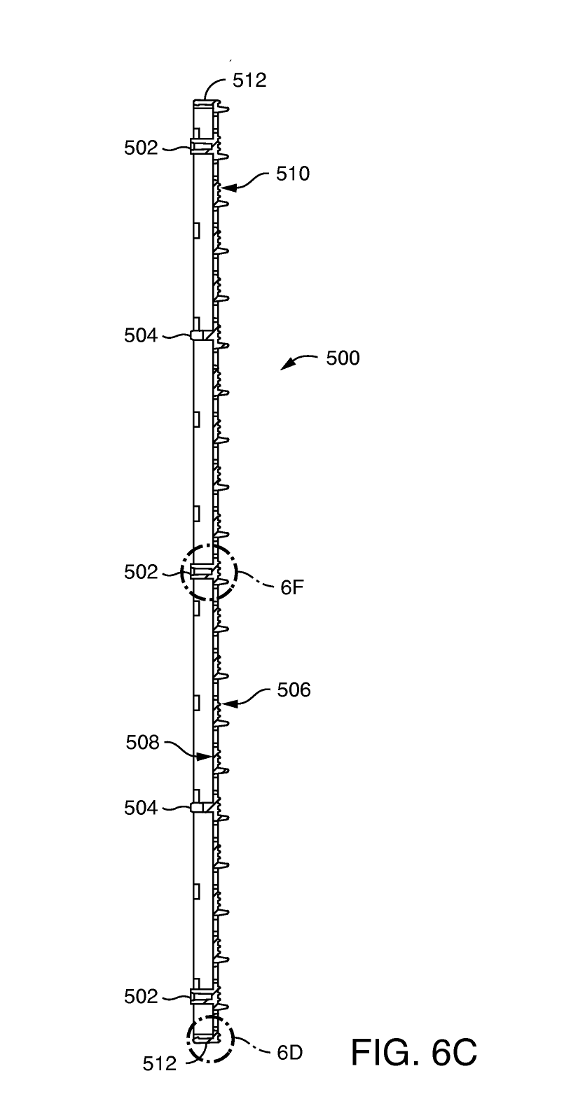

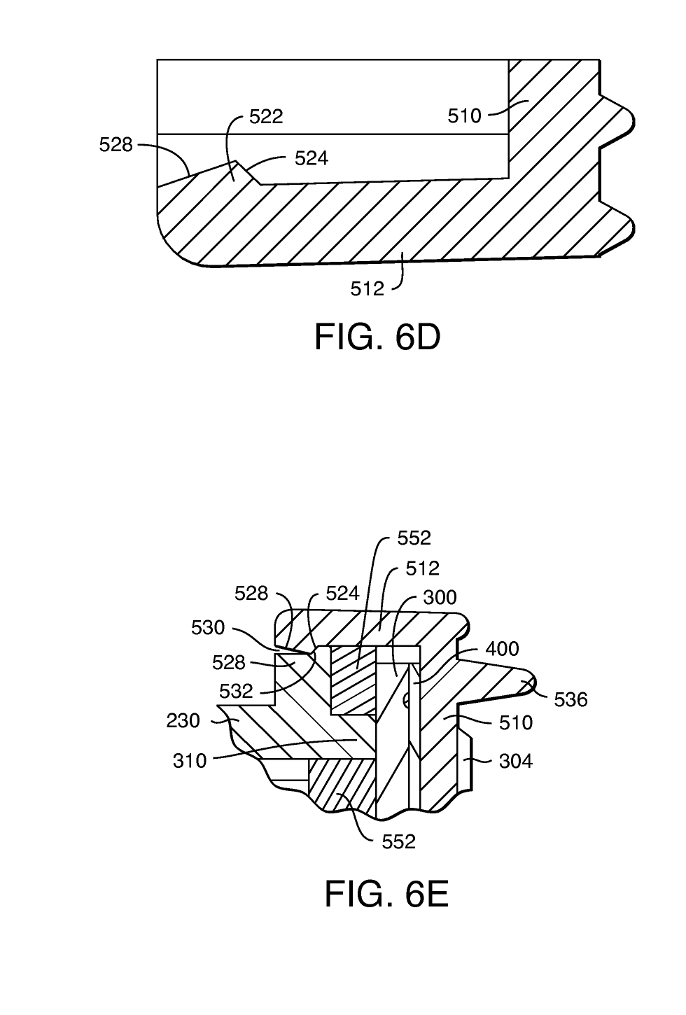

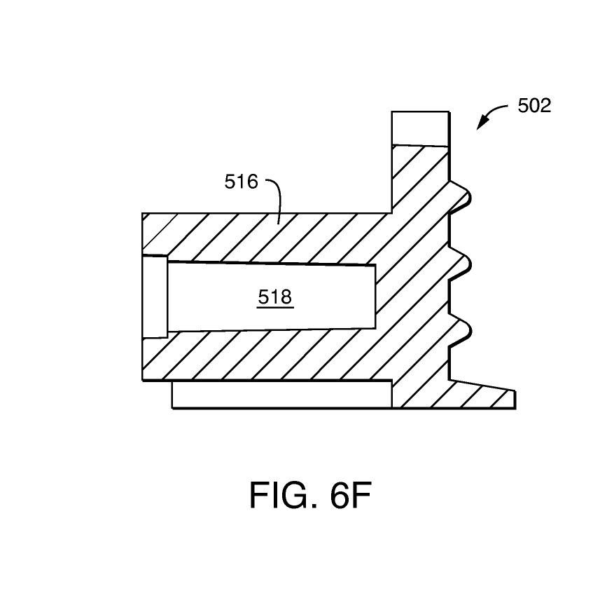

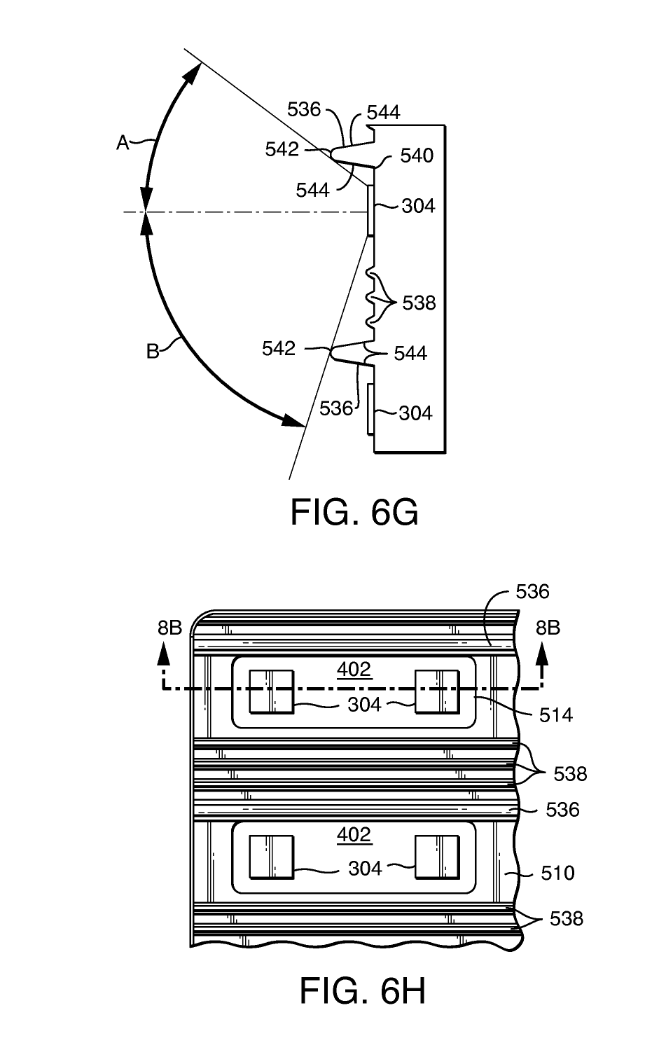

A plurality of the louver bolt bosses 502 and a plurality of the louver snap-fit prongs 504 extend rearward from rear face of the video panel 510. As depicted in FIG. 6F, the louver bolt bosses 502 comprise a cylindrical wall 516 defining a bolt hole 518. The outer dimension of the louver bolt boss cylindrical wall 516 is dimensioned to fit within the bolt aperture 258 of the PCB mount bolt boss 240 on the frame 202. When the video block 200 is assembled, the louver 500 is associated with the PCB 300 such that the louver bolt bosses 502 extend through the PCB louver bolt boss apertures 312 and the louver 500 is also associated with the frame 202 such that the louver bolt bosses 502 extend into the bolt aperture 258 of the PCB mount bolt boss 240 of the frame 202, as depicted in FIGS. 3D and 3E, until the distal end of the louver bolt boss cylindrical wall 516 axially abuts against the bolt receiving wall 262. The threads of a bolt 520 (or screw) are slid through the narrowed bolt aperture 264 of the PCB mount bolt boss 240 and into the inner side of the louver bolt boss cylindrical wall 516 to engage (or cut) associated threads therein and draw the head of the bolt 520 against the bolt receiving wall 262 thus securing the louver 500 to the frame 202. The louver 500 is secured to the frame 202 with enough bolts 250 in this manner as required by the size and weight of the louver 500 and PCB 300 to secure both to the frame 202, when the number of snap-fit connections with the louver snap-fit prongs 504 is also taken into consideration.

The exemplary video block 200 also comprises the louver snap-fit prongs 504 extending from the louver rear face 508. The louver snap-fit prongs 504 comprise a snap-fit post of sufficient length to extend from the louver 500, though the PCB 300 and snap-fit into an associated PCB stabilizer boss 242. The snap-fit is accomplished by splitting the distal end of the post into two, or more, opposing prongs with barbs at the end of each such that the barbs deflect the prongs inward while being inserted through the PCB stabilizer boss narrowed entry aperture 274 and then snapping back once the barbs pass the inwardly projecting wall 272 at the distal end of the PCB stabilizer boss 242 and locking the louver snap-fit prong 504 in place. Preferably, the louver snap-fit prong 504 is of a construction allowing it to be removed from the frame 202, upon application of sufficient force, without damaging either the louver 500 or the frame 202.

The louver snap-fit prongs 504 may be used in addition to, or in place of, the bolts 250, louver bolt bosses 502 and the PCB mount bolt bosses in the manner described below. Alternatively, the louver snap-fit prongs 504 need not be used at all. Preferably, the video block 200 uses a combination of bolts 250 and louver snap-fit prongs 504 to properly secure the louver 500 and PCB 300 to the frame 202 that minimizes the use of bolts 250 because of the labor required to secure the screws while the louver snap-fit prongs 504 secure to the PCB stabilizer boss 242 by simply pressing the louver 500 into the frame 202, or by associating the two and drawing them together by tightening the bolts 250, if any are used. This configuration facilitates secure assembly of the video block 200 with minimum assembly time and labor. In this assembled configuration, the PCB stabilizer boss flat 270 and the cylindrical wall flat 260 of the PCB mount bolt boss both abut against the PCB 300 such that the PCB 300 is captured between the louver 500 and the frame 202 in addition to being secured due to the bolts 250 and the louver snap-fit prongs 504 extending through the louver bolt boss apertures 312 and the louver snap-fit prong apertures 324, respectively.

The louver flange 512 extends rearward of the louver panel 510 and includes one or more barbs 522 located about its perimeter on its distal end, extending inward. Each barb 522 forms a flat locking edge 524 extending inward of the louver flange 512 at an angle, which is shown as 45° for a distance of 0.46 mm in the preferred embodiment. However, this angle can be any angle sufficient to cause the louver flange to lock over the louver locking flange 528 on the frame 202, which is described below. Each barb 522 also includes a deflection face 526 running inward of the louver flange 512 from the distal end to the innermost portion of the flat locking edge of the barb 524. The deflection face 526 of each barb 522 forces the louver flange 512 to deflect outward over the louver locking flange 528 of the frame 202 to allow the barb 522 to pass the louver locking flange 528 of the frame 202.

A louver locking flange 528 extends outwardly from the outer perimeter beam wall 230 about the perimeter of the frame 202 to define a portion of the frame front face 218. The louver locking flange 528 defines one or more locking recesses 530 in its distal end, one each associated with each barb 522 on the louver flange 512. Each locking recess 530 includes an angled locking face 532 angled rearward and inward to form a recess in the louver locking flange 528 in which the louver locking flange barb 522 can rest with the angled locking face 532 of the recess 530 resting against the flat locking edge 524 of the locking flange barb 522 as depicted in FIG. 6E. Thus configured, the perimeter of the video panel 510 of the louver 500 is securely held against the frame 202 to prevent curling or other deflection of the perimeter of the video panel 510 away from the frame 202, which can cause aesthetic deficiencies, block light emitted from one or more LEDs 304 and/or allow or direct rain, snow or other elements into the video block 200 and cause premature failure of one or more LEDs 304 or other electrical elements or connections.

As can be seen (for example in FIGS. 6C, 6F and 6G) a plurality of ribs 534 extend forward from the louver front face 506. In the exemplary embodiment, the plurality of ribs 534 includes a main rib 536 extending forward from the louver front face 506 above an adjacent LED aperture 514 and one or more (three in the exemplary embodiment) light trap ribs 538 extending forward from the louver front face 506 below an adjacent LED aperture 514, as depicted in FIGS. 6G and 6H. In the depicted embodiment, each of the plurality of ribs 534 runs horizontally across the entire width of the louver 500. In an alternative embodiment, the ribs 534 run only adjacent to LED apertures 514, but not between them, or only adjacent to the LEDs 304. The main rib 536 extends outward from a base 540 at the front face 506 of the louver video panel 510 to a distal end 542 and defines upper and lower walls 544. The main rib distal end 542 is spaced sufficiently from the louver front face 506 (i.e. the “height” of the main rib) and the main rib base 540 is spaced sufficiently from the LED 304 in the adjacent LED aperture 514 such that the main rib distal end 542 forms an angle A from perpendicular to the louver front face 506 with the uppermost edge of the LED 304, as depicted in FIG. 6G. In this configuration, the main rib 536 shields the LED 304 from some direct sunlight in order to limit the amount of direct sunlight on the LED 304, which can “wash out” the light emitted from the LED 304 and diminishing perceived brightness of that LED 304. This configuration also shields portions of the louver video panel 510 from sunlight in order to prevent the sunlight from creating glare on the louver video panel 510. Further, the video board 100 might be installed in a location, such as a sports stadium, in which some viewers may be located above the video board 100 and need a line of sight to the LEDs 304 that is unobstructed by the main ribs 536. In one preferred embodiment, then, angle A is designed to provide a direct line of sight between all viewers and the LEDs 304 in most installations, while still shading the LEDs 304 from as much direct sunlight as possible. In the depicted embodiment, angle A is 37° and the height of the main rib 536 is 3.5 mm. An angle A of 37° can be achieved by other combinations of heights and spacing of the main rib 536. Other angles A are also contemplated as appropriate to achieve the dual purposes of providing viewers with a direct line of sight to the LEDs 304 while providing as much shade to the LEDs 304 as possible to prevent washout. Because LEDs are capable of being driven to produce high lumens, the main rib 536 may not be necessary in all applications. However, no matter how brightly the LEDs 304 are driven, power savings can be achieved by use of the main rib 536 to shade the LEDs 304 to reduce the brightness at which the LEDs 304 must be driven to achieve the same perceived brightness. In the depicted embodiment, the LED apertures 514 are arranged on the louver video panel 510 in a matrix of rows and columns and one main rib 536 extends across the top of each row of LED apertures 514, spanning the entire width of the louver video panel 510. Other configurations are also contemplated to achieve the stated goals.

Viewers of the video board 100 are located below the video board 100 in some applications. Some of these viewers can be located close to the video board 100. In order to provide these viewers with a direct line of sight to the LEDs 304, each main rib that is below an LED 304 is spaced a greater distance below the LED 304 than it is spaced above the LED 304 immediately below. In this configuration, eventhough the main ribs 536 all have the same height to provide approximately even shading from sunlight, viewers underneath the board can have a direct line of sight to the LEDs 304 when they are closer to the video board 100 than viewers above the video board 100. That is, the main rib distal end 542 forms an angle B with the lower end of the LED 304 (as depicted in FIG. 6G) that is substantially greater than angle A. In a preferred embodiment, angle B is approximately twice angle A. In one preferred embodiment, angle B is 72°.

In the exemplary embodiment depicted in FIG. 6G which includes the preferred embodiment of angle A being 37°, angle B being 72° and the height of each main rib 536 being 3.50 mm, the LEDs 304 are located on the PCB 300 and the PCB is located with respect to be frame 202 and louver 500 such that the outermost surface of the LEDs 304 protrude 0.010 inches beyond the video panel of the louver 510. Other angles and magnitudes of protrusion are contemplated. The LEDs 304 protrude beyond the louver video panel 510 in this manner so that they protrude through LED potting 402 that encases and protects portions of those LEDs 304 and their connections to the PCB 300. By configuring the LEDs 304 to protrude beyond the louver video panel 510, all or a majority of the light emitting portions of the LEDs 304 are free of the potting 402, thus preventing the LED potting 402 from blocking the light emitted from the LEDs 304. Furthermore, configuring the video block 200 such that the LEDs 304 protrude beyond the louver video panel 510 also facilitates viewing of the video board 100 from extreme angles to the face of the video board 100. If the LEDs 304 were even slightly recessed with respect to the louver video panel 510, the light emitted from the LEDs 304 would be blocked by the louver video panel 510 itself from the line of sight of some viewers, including viewers at the side of the video board 100 for which a direct line of sight is not blocked by any of the ribs 534. If the LEDs 304 were flush with the louver video panel 510, the light emitted from the LEDs 304 could be blocked from the line of sight of a viewer by any imperfection in the louver video panel 510 or an improper application of LED potting 402. With the video blocks 200 configured such that the LEDs 504 protrude beyond the louver video panel front face 506 as discussed, viewers are guaranteed a direct line of sight to the LEDs 504 from above (until blocked by the upper main rib 536), from below (until blocked by the lower main rib 536) and from the sides up to almost 0° from the plane defined by the louver video panel 510. In practice, it has been found that the protruding LEDs 504 discussed above will facilitate viewing from at least 5°, or less, from the plane defined by the louver video panel 510.

The light trap ribs 538 are located below each LED aperture 514. Aside from the plurality of ribs 534, the louver video panel 510 is generally flat, which can result in glare off of the louver video panel 510 from ambient light. The light trap ribs 528 break up the generally flat space between a LED aperture 514 and the main rib 536 below it that could otherwise permit glare. This is accomplished by configuring the light trap ribs 538 with a somewhat rounded cross-section to deflect small amounts of light in a plurality of various directions. The light trap ribs also create shadow on the portion of louver video panel 510 immediately below when sunlight hits the video board 100 from an angle above horizontal. This shadow creates a dark area under the LEDs 304 increasing the perceived brightness of the LEDs 304 due to contrast. The depicted embodiment uses three light trap ribs 538 extending to a height of 0.64 mm from the louver front face 506 and spaced 2.0 mm from each other. More ribs with a shorter height or fewer ribs with a greater height could accomplish the same goal. Alternatively, the surface of the louver video panel 510 could be configured to reduce glare with stippling, anti-glare material, paint or other coating, etc. Like the main rib 536, the light trap ribs 538 extend across the entire width of the louver video panel 510 underneath each row of LED apertures 514 in the depicted embodiment. Other configurations are also contemplated to achieve the stated goals.

The LED potting 402 encases at least the connection of each associated LED 304 to the PCB 300 to shield it from the environment and prevent or inhibit the degradation of the LED 304 or it connections (generically referenced herein as “legs”) caused by the environment, as discussed above. Moisture and humidity are primary examples. Portions of each LED 304 must remain free of the LED potting 402 for the viewing reasons, as discussed above. In one embodiment, the LED potting 402 encases the entirety of the LED legs (not depicted) connecting each LED 304 to the PCB 300 and a sufficient amount of the corresponding LED 304 and surrounding portion of the PCB 300 to ensure that the LED legs remain encased in LED potting 402.

While the connection between the LEDs 304 and the PCB 300 are of primary concern, it is also desirably to shield the entire PCB front face 302 from the environment. However, the cost of acceptable potting materials is very high at present. Therefore, the video blocks 200 each comprise a louver gasket 400 having a louver gasket web 404 defining at least one LED aperture 406 for associating with a plurality of LEDs 304 associated with one of the LED apertures 514 in the louver 500. The louver gasket 400 covers the entire PCB 300 and has an LED aperture 406 associated with each LED aperture 514. The louver gasket 400 could, however, be broken up into multiple gaskets to accomplish the same function. Each LED aperture 406 defines an open edge 408 in the louver gasket web 404 extending about the LED aperture 406. A rib 410 extends from the web 404 either about the louver web open edge 408 or somewhat back from the louver web open edge 408 onto the louver gasket web 404. The rib 410 constitutes the thickest portion of the louver gasket 400 such that when inserted between the PCB 300 and the louver 500 and assembled to the frame 202, the rib 410 is compressed between the PCB 300 and the louver 500. In this compressed state, the rib 410 forms a seal between the ambient environment, which has access to the portions of the PCB 300 adjacent a LED aperture 406 in the louver gasket 400, and the remainder of the PCB 300. In this compressed state, the rib 410 also forms a seal to prevent LED potting 402 from escaping the louver gasket LED aperture 406 when placed onto the PCB 300 to encase the LED legs and the connection between the LED legs and the PCB 300.

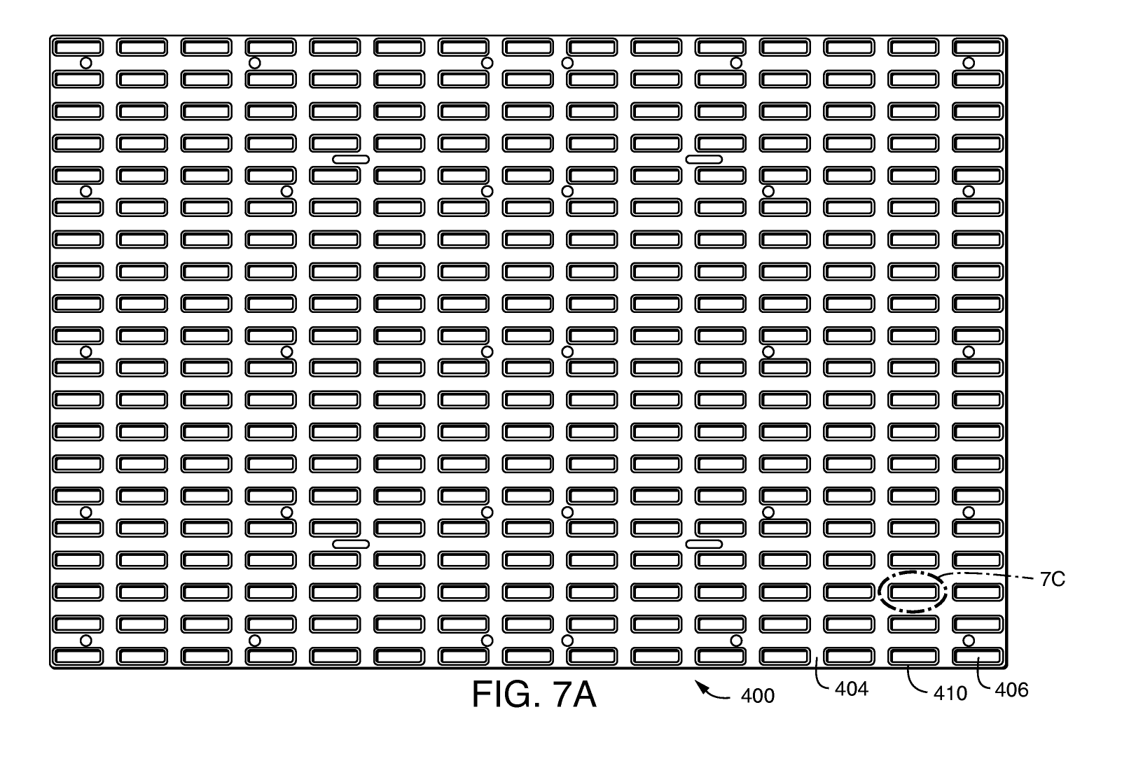

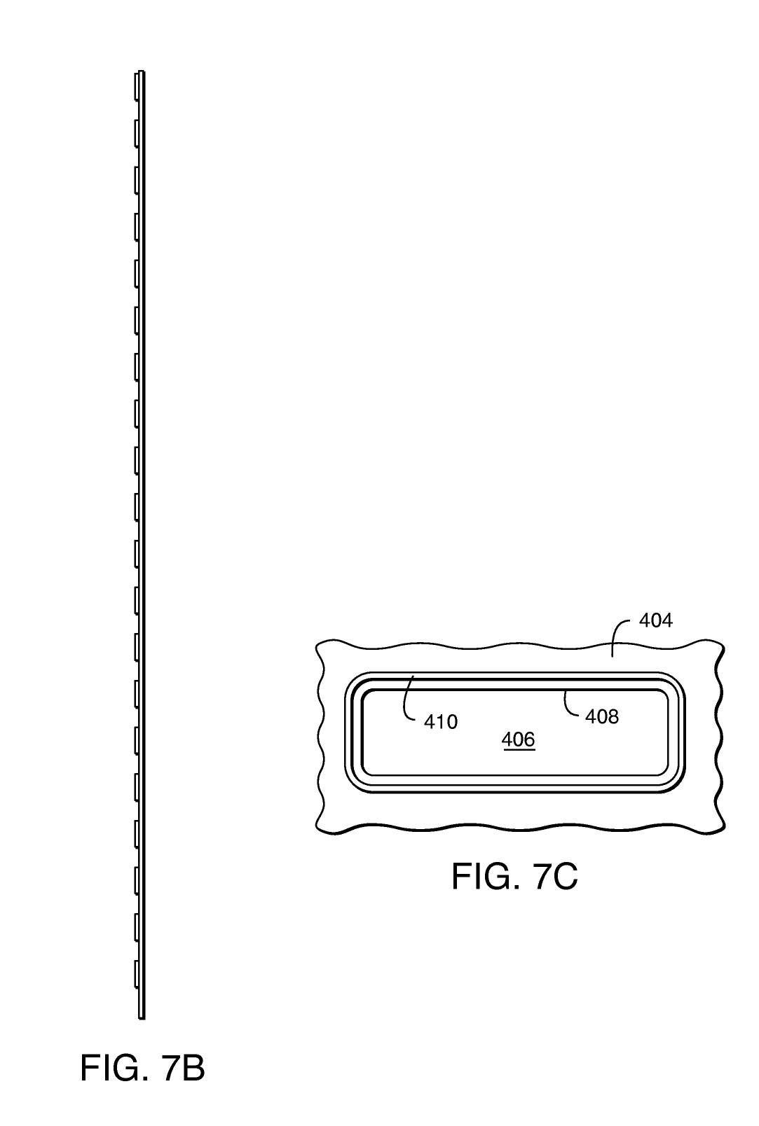

An exemplary louver gasket 400 is depicted in FIGS. 7A and 7B with an outtake in FIG. 7C focusing on a single LED aperture 406 and its rib 410. In this exemplary embodiment, the rib 410 is locate back onto the gasket web 404 from the open edge 408 of the LED aperture 406. In this exemplary embodiment, the rib 410 extends from the web only on the side of the louver gasket 400 facing the PCB 300 and is of a semi-circular form in cross-section with a radius of curvature of approximately 0.25 mm while the gasket web 404 is approximately 0.5 mm thick. Other rib configurations are contemplated and a second rib on the reverse side of the gasket web 404 is also contemplated.

Assembly of the video block comprises the steps of, in no particular order: inserting a frame mount insert nut 550 into one or more of the frame mount nut bosses 238 on the frame 202; placing the louver gasket 400 onto the rear face of the louver 500; bringing the front face 302 of the PCB 300 onto the louver gasket 400 such that the louver snap-fit prongs 504 protrude through the louver snap-fit prong apertures 314 and the louver bolt bosses 502 protrude through the louver bolt boss apertures 312; inserting the louver snap-fit prongs 504 of the louver 500 into the PCB stabilizer bosses 242 of the frame 202; bringing together the louver 500 and the frame 202 to compress the louver gasket rib 410; achieving snap-fit connection between the louver 500 and the frame 202; inserting bolts 520 through one or more of the PCB mount bolt bosses 240 and into an associated louver bolt boss 502; and tightening the bolts 520 until the louver 500 is secured to the frame.

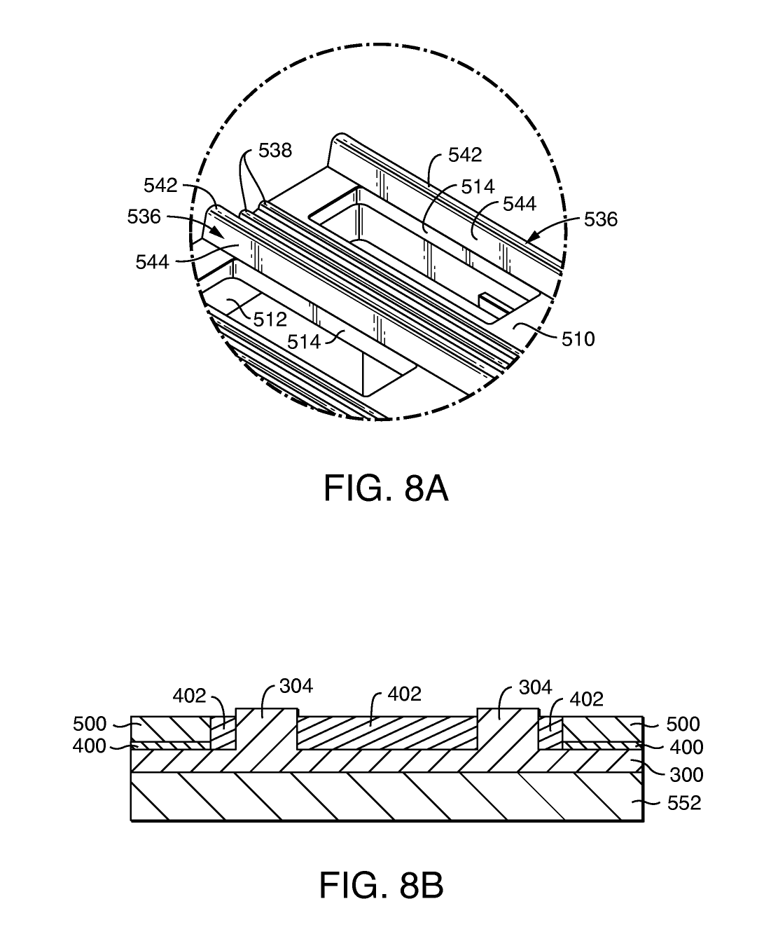

FIG. 8B depicts a cross-sectional view of the PCB 300, louver 500 assembled with the louver gasket 500 there between, taken through one LED aperture 514 in the louver video panel 510, which corresponds with one LED aperture 406 in the louver gasket 400. The louver rib 410 is compressed in this assembled configuration and thus not distinguishable from the web 404. FIG. 8B further depicts the LED potting covering all portions of the PCB exposed by the LED aperture 406 in louver gasket web 404. The LED potting 402 is installed after the assembly of the video block 200 by injecting it through the LED aperture 514 in the louver video panel 510 and letting it flow across the PCB 300. At that time, the louver rib 410 of the louver gasket 400 has already been compressed and thus prevents flow of the LED potting 402 beyond the LED aperture 406 in the louver gasket web 404. In this configuration, the LED potting 402 fills the LED aperture 406 in the louver gasket web 404 and accumulates until it reaches, or alternatively approaches, the LED aperture 514 in the louver video panel 510. A majority of each LED 304 and its connectors to the PCB 300 are thus encased in a pool of LED potting 402. When applied across the video block 200, the entirety of the front face of the PCB 302 is protected from the environment by either being covered by LED potting 402 or by being sealed off from the environment by the louver gasket 400.

As indicated above, the LED aperture 514 in the louver video panel 510 and the corresponding LED aperture 406 in the louver gasket web 404 can circumscribe one or more LEDs 304 and differing ones of the LED apertures 514, 406 can circumscribe different numbers of LEDs 304. The fewer the number of LEDs 304 in each of the LED apertures 514, 406, the less LED potting 402 used per LED 304, while the greater the number of LEDs 304 in each of the LED apertures 514, 406, the greater the amount of LED potting 402 used per LED 304. This is because of the space between LEDs that must be covered when more than one LED 304 is in an LED aperture 514, 406. Additionally, however, the fewer the number of LEDs 304 in each LED aperture 514, 406, the greater the number of LED apertures 514, 406 that must be filled with LED potting 402 to pot all of the LEDs 304. Each additional LED aperture 402 requires either an additional potting injection step, or a separate injection nozzle and thus increases manufacturing costs. In one embodiment, then, the number of LEDs 304 in each of the LED apertures 514, 406 strikes a balance between the costs of injecting the LED potting 402 and the costs of the LED potting 402 itself. In the depicted exemplary embodiment, each of the LED apertures 514, 406 circumscribes two LEDs 304. Greater or fewer LEDs 304 per LED aperture 514, 406 or varying numbers of LEDs 304 per aperture 514, 406 are contemplated. Once the LED potting 402 is applied across the PCB 300, each LED 304 resides in a pool of LED potting 402 and each pool of LED potting 402 can comprise one or more LEDs 304. In the preferred embodiment, two LEDs 304 reside in each pool of LED potting 402, as depicted.

The LED potting 402 preferably has a viscosity sufficient to allow it to flow around the LEDs 304 and preferably around the connections between the LEDs 304 and the PCB 300. The LED potting 402 is preferably opaque and, more preferably, black to minimize reflection of ambient light and to maximize contrast with the light emitted from the LEDs 304 when in operation. For these same reasons, the louver 500 is preferably also black. Preferably, the LED potting 402 and louver 500 are the same, or approximately the same, color. Furthermore, the LED potting 402 is preferably soft after it has cured so that it can be somewhat easily cut and removed to permit repairs to the PCB 300 and its components. In one embodiment, the LED potting 402 is a two part silicone S2600 from Beijing Three Man Technology Co Ltd. Dow SE9187L from Dow Corning is also a preferred LED potting 402.

In an exemplary embodiment, all of the electrical components of the PCB 300 other than the LEDs 304 are mounted to the PCB rear face 308 to allow the LEDs 304 to protrude beyond the louver video panel 510, as discussed above, without extending the LEDs 304 too far from the PCB 300. The electrical components on the PCB rear face 308 and the connections between those components and the PCB 300 are susceptible to degradation due to moisture or other environmental impacts. To limit or preclude the access of environment to these components or their connection to the PCB 300, the PCB rear face 308 is covered in PCB potting 552 in one embodiment. In the depicted embodiment, the entire PCB rear face 308 is covered in the PCB potting 552. Preferably, the PCB potting 552 is only as thick as necessary to cover the connection of the electrical components to the PCB 300 in order to minimize the required volume of PCB potting 552 and, thus, minimize the cost of PCB potting 552. In another embodiment, however, the electrical components are also completely covered with PCB potting 552.

In one exemplary embodiment, the frame 202 is configured to facilitate flow of the PCB potting 552 across nearly the entirety of the PCB rear face 308 with as little impediment to its flow as possible. To that end, the frame 202 is configured in this exemplary embodiment to touch the PCB rear face 308 only at (i) the flat 260 of the cylindrical wall 256 of the PCB mount stabilizer boss 242, (ii) at the flat of PCB stabilizer boss 270 and (iii) the spacer nubs 310. Thus, the inner perimeter beam walls 228 do not extend close enough to the PCB 300 so as to touch the PCB 300 or to prevent flow of the PCB potting 552 there between. Similarly, except for the flat 260 of the cylindrical wall 256 of the PCB mount stabilizer bosses 242 and the flat of PCB stabilizer bosses 270, no part of the frame central internal vertical brace 212, the frame first side internal vertical brace 214, or the frame second side internal vertical brace 216 extend close enough to the PCB 300 so as to touch the PCB 300 or to prevent flow of the PCB potting 552. In this exemplary configuration, PCB potting 552 can be injected onto the PCB rear face 308 in one location and allowed to flow over all electrical components on the PCB rear face 308 and connections of such electrical components to the PCB 300. Multiple injection sites area also contemplated. Other variations are contemplated. For example, any of the internal vertical braces 212, 214, 216 could extend to and touch the PCB 300 and PCB potting 552 could be applied in more than one injection step.

The PCB potting 552 preferably has the same characteristics as those described above for the LED potting 402 except that the color need not be opaque or black because the PCB potting 552 is on the back of the PCB 300 and need not provide contrast with the LEDs 304. In one embodiment, translucent PCB potting 552 allows viewing of the electrical components on the back of the PCB 300 to facilitate easier change or repair. In two preferred embodiments, the PCB potting 552 is the same potting used for the LED potting 402: (1) two part silicone S2600 from Beijing Three Man Technology Co Ltd., or (2) Dow SE9187L from Dow Corning.

Once the frame 202, PCB 300, louver gasket 400 and louver 500 have been assembled, as discussed above, manufacture of the video block 200 includes, in no particular order, the steps of: applying the LED potting 402 into the louver LED aperture 514 and the louver gasket LED aperture 406 until at least the connections between the LED 304 and the PCB 300 are covered in LED potting 402; curing the LED potting 402; applying the PCB potting 552 until at least the connections between the electrical components and the PCB 300 are covered or until the entirety of the electrical components are covered; and, curing the PCB potting 552.

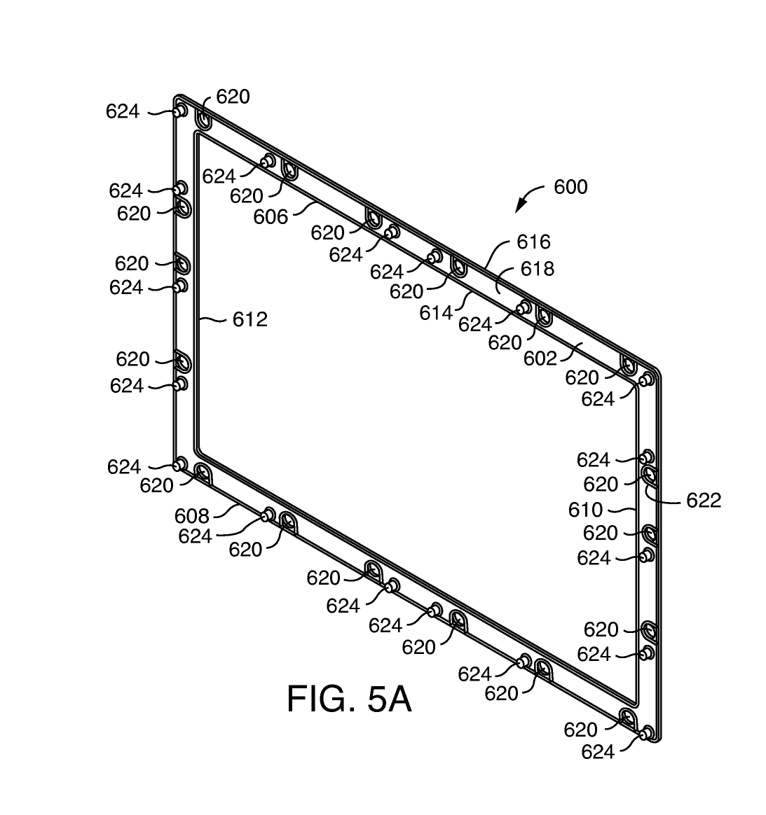

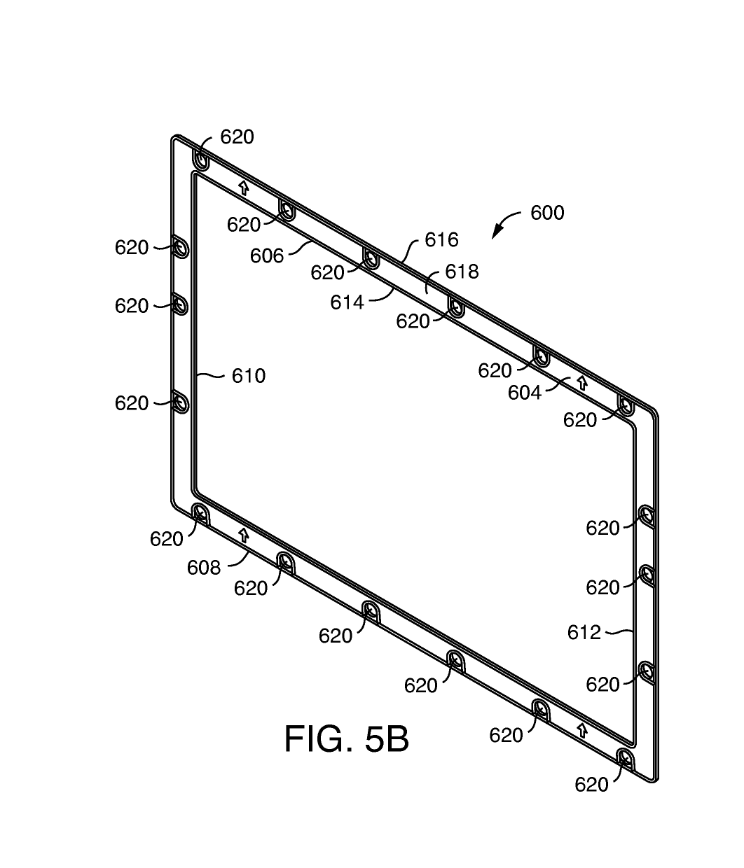

With the video block 200 thus assembled, it may be mounted to the cabinet 102. It is preferred that the connection of the video block 200 to the cabinet 102 be sealed to keep environmental elements such as rain and snow out of the cabinet 102. Such a seal also provides greater control over air circulation within the assembled video board 100. In the exemplary embodiment, this seal is provided by the frame gasket 600 depicted in FIGS. 5A and 5B, among others. The frame gasket 600 has a front face 602 engaging the frame 202 and facing in the forward facing direction of the video block 200, and a rear face 604 facing the opposite direction. The frame gasket 600 is configured to reside in the frame gasket channel 226 formed by the frame inner and outer channel walls 222, 224 and the rear face wall of the perimeter beams 232. The frame gasket 600 therefore has upper and lower horizontal portions 606, 608 to reside in the upper and lower horizontal perimeter beams 204, 206 and first and second vertical portions 610, 612 to reside in the first and second vertical perimeter beams 226, 228. A cross-section of the upper and lower horizontal portion 606, 608 is provided in FIG. 3E. As can be seen there, the exemplary embodiment of the frame gasket 600 comprises an inner bead 614 and an outer bead 616 connected by a frame gasket web 618. The inner and outer beads 614 of the frame gasket 600 are compressed against the frame 202 and the cabinet 102, as discussed below, to create a seal against the environmental elements. The sealing function accomplished by the inner and outer bead 614, 616 allow the frame gasket web 618 to only be as thick as necessary to provide it the structural integrity to hold the frame gasket 600 together. The bead and web configuration of the frame gasket 600 therefore reduces the overall material cost of the frame gasket 600 with respect to a gasket that was of even thickness.

The frame gasket 600 also defines a frame mount insert nut aperture 620 to associate with each frame bolt aperture 248 in order to permit access to the frame mount insert nut 550 such as by a bolt to mount the video block 200 to the cabinet 102. In the depicted embodiment, the frame mount insert nut aperture 620 circumscribes the bolt aperture stabilizers 254 and a frame mount insert nut aperture bead 622 extends out of both the front face 602 and rear face 604 the frame gasket web 618 to provide a seal around the frame mount insert nut aperture 620. In the depicted embodiment, the inner bead, 614, outer bead 616 and frame mount insert nut aperture bead 622 all extend from both the web 618 on both the front face 602 and the rear face 604 of the frame gasket 600, but extends from just the front face 602 or just the rear face 604 in alternative embodiments, not depicted. Another aperture, identical to the frame mount insert nut apertures 620, is formed to circumvent the one or more frame locator prongs 299.

The frame gasket 600 further comprises one or more plugs 624 extending from the front face 602 of the web 618. The one or more plugs 624 are cylindrical in shape and are of a diameter approximately the same as, or slightly greater than, apertures on the rear face of the frame 202 by the PCB mount bolt bosses 240 and the PCB stabilizer bosses 242 (i.e. aperture 268). Each of the one or more plugs 624 are located on the frame gasket 600 so as to insert into the associated aperture defined on the rear face of the frame 202 by the PCB mount bolt bosses 240 and the PCB stabilizer bosses 242 (i.e. aperture 268) and hold the frame gasket 600 in place. The diameter of one or more of the plugs 624 is slightly greater than the associated aperture so that a force fit is formed. In the depicted embodiment, the frame gasket 600 has a plug associated with each of the apertures defined on the rear face of the frame 202 by the PCB mount bolt bosses 240 and the PCB stabilizer bosses 242 (i.e. aperture 268). In an alternative embodiment, not depicted, the frame gasket 600 has a plug 624 associated with just the apertures defined on the rear face of the frame 202 by the PCB mount bolt bosses 240 or just the PCB stabilizer bosses 242 (i.e. aperture 268). In yet another alternative, the frame gasket 600 has a plug 624 associated with four of the apertures defined on the rear face of the frame 202 by the PCB mount bolt bosses 240 or just the PCB stabilizer bosses 242 (i.e. aperture 268), one of which is located in each corner of the frame 202. Other embodiments are also contemplated.

In one embodiment, one or more of the plugs 624 has a notch (not depicted) running axially from the base of the plug 624 adjacent the web 618 to the distal end of the plug 614 at the circumference of the plug 624. This allows the air pressure in the aperture in which the plug 624 resided to equalize with the ambient air pressure, preventing pressure build-up during insertion of the plug 624 and vacuum during removal of the plug 624.

The frame gasket 600 is constructed of a material to be flexible compressible and durable. In one embodiment, the frame gasket 600 is constructed of a silicone having 20 A Durometer hardness. Other materials and hardnesses are contemplated.

Thus configured, the frame gasket 600 is associated with the frame 202 by locating the one or more plugs 624 adjacent the corresponding PCB mount bolt bosses 240 and/or PCB stabilizer bosses 242 (i.e. aperture 268) and inserting the plugs 624 as far as possible. By doing so, the frame mount insert nut apertures 620 are automatically aligned with the corresponding frame bolt apertures 248 due to their location on the frame gasket 600.

Thus configured, the frame 202 and frame gasket 600 combinations are associated with the appropriate block aperture 136 on the appropriate cabinet 102. The locator prongs 299, if any, are aligned with and inserted into the locator holes 140 associated with the appropriate block aperture 136. Then bolts are inserted through the mounting holes 138 in the vertical and horizontal beams 132, 134 of the cabinet face and advanced into the frame mount insert nuts 550 until the frame 202 is tight against the face of the cabinet 102 and the frame gasket beads 614, 616, 624 are compressed against the vertical and horizontal beams 132, 134 of the cabinet face to form the appropriate seal. This is continued until the block apertures 136 on the cabinet 102 are fully populated.

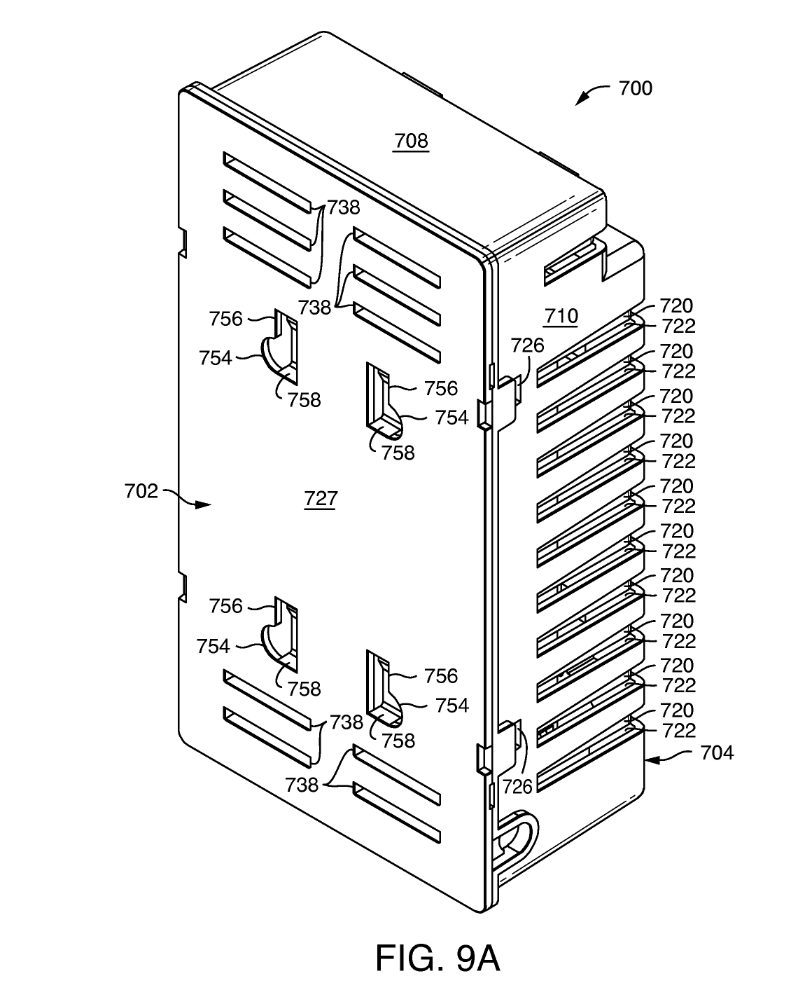

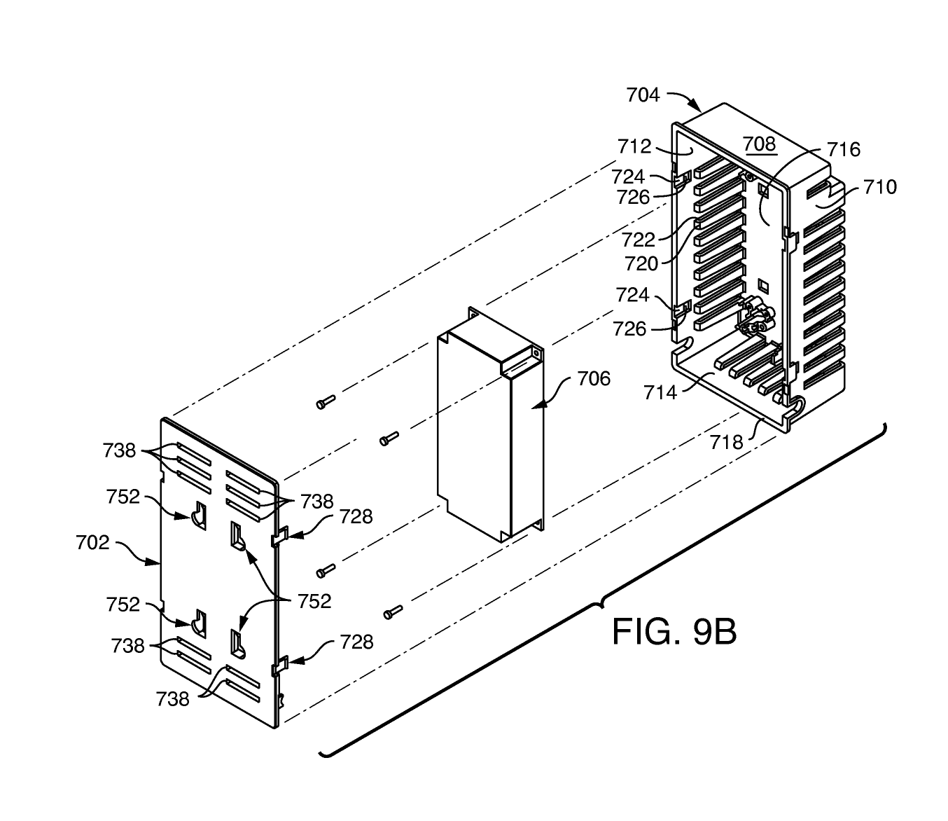

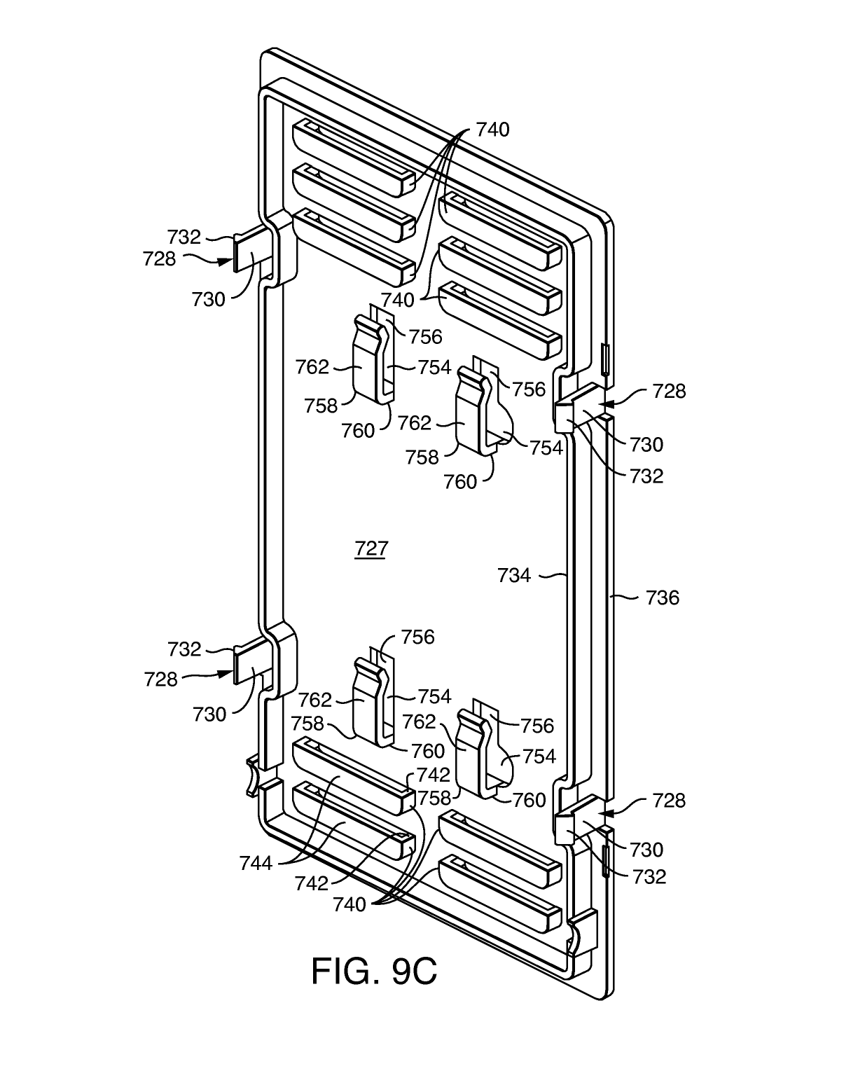

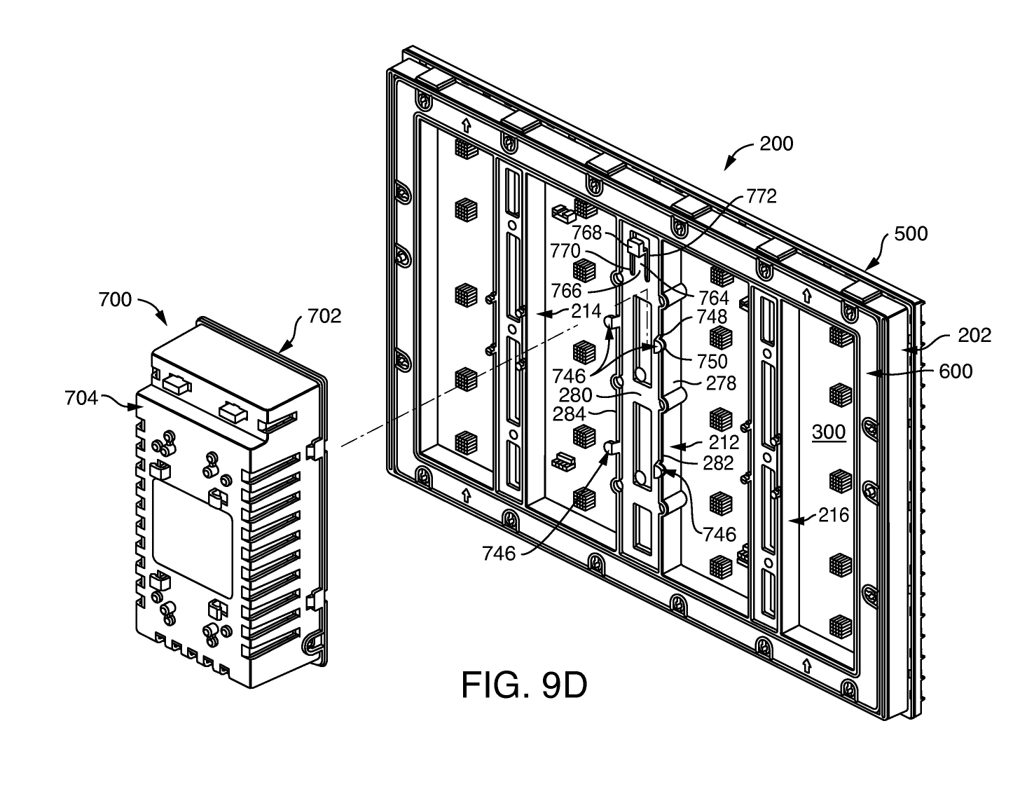

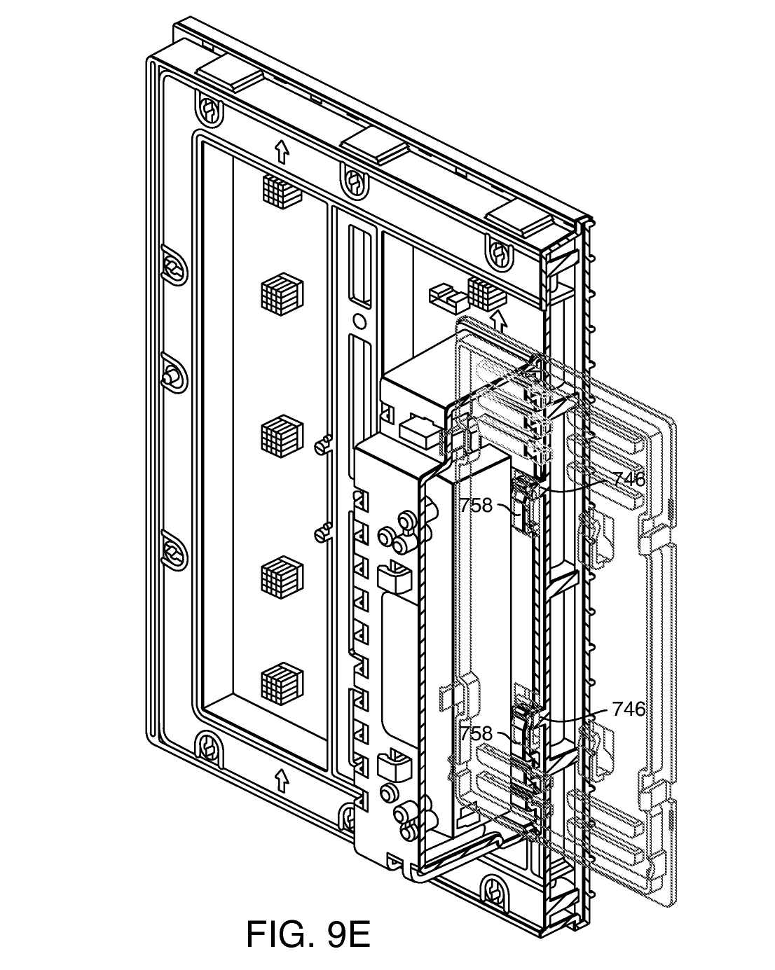

An exemplary embodiment of the power supply case 700 is depicted in FIGS. 9A through 9E and comprises a base plate 702 and enclosure body 704 in which a power supply unit 706 is enclosed. The enclosure body 704 comprises a top perimeter wall 708, a first side perimeter wall 710, a second side perimeter wall 712, a bottom perimeter wall 714 and a rear plate 716. The perimeter walls 708, 710, 712 and 714 define an open front face 718 of the enclosure body 704. The first and second side perimeter walls 710, 712 and the bottom perimeter wall 714 have a plurality of ribs 720 recessed from the remainder of these walls 710, 712, 714 so as to define openings 722 between each side of each of the ribs 720 and the remainder of the walls 710, 712, 714 from which the extend. The openings 722 permit air flow into and out of the power supply case 700 to cool the power supply unit 706. However, because the openings 722 are created by recessing the ribs 720 into the enclosure body 704, the openings 722 are not upwardly open without coverage above the opening 722. As a result, water, snow, etc. cannot drip downward into the power supply case 700 directly through the opening 722. In the depicted embodiment, no ribs 720 or openings 722 are located on the top perimeter wall 708 of the enclosure body 704 in order to prevent rain, snow, etc. from running into the power supply case 700. Fewer or more of the perimeter walls 708, 710, 712, 714 could have ribs 720 or other structure to facilitate air flow and ribs or such other structure could also reside on the rear plate 716 as well.

The forwardmost portion of the first and second side perimeter walls 712, 714 each have comprise a pair of recesses 724 on the inner side thereof. The recesses 724 extend rearward and end adjacent to an opening 726. The base plate 702 comprises a plate 727 configured to engage and close off the open front face 718 of the enclosure body 704. A plurality of assembly prongs 728 extend rearward of the plate 727, one each associated with the recesses 724. Each assembly prong 728 has an arm 730 and a barb 732 at the distal end thereof. During assembly of the base plate 702 to the enclosure body 704, the barbs 732 are deflected inward by flexure in the arm 730 until the barbs 732 reach their respective opening 726 allowing them to relieve the flex stress in the arm 730 by snapping into the opening 726 and allowing the arm 730 to rest in the recess 724. Once all four barbs 730 rest in their respective openings 726, the base plate 702 and the enclosure body 704 are secured to one another, but can be separated by pressing the barbs 730 back into the opening 726 and separating the base plate 702 from the enclosure body 704. Other numbers of assembly prongs 728 and other structures are contemplated for releasably connecting the base plate 702 and the enclosure body 704.

A rim 734 extends rearward of the base plate 702 in the form of a short wall extending perpendicular to the plate 727. The rim 734 extends from the plate 727 slightly inward of an outer perimeter 736 of the plate 727 such that the rim 734 resides immediately inside the perimeter walls 708, 710, 712, 714 of the enclosure body 704. The plate outer perimeter 736 extends approximately to an outer perimeter of the perimeter walls 708, 710, 712, 714 at the enclosure body open front face 718. In this configuration, the plate 727 outer perimeter 736 works in conjunction with the assembly prongs 728 to axially (i.e. frontward/rearward) hold the base plate 702 at the enclosure body open front face 718 while the rim 734 prevents lateral movement between the base plate 702 and enclosure body 704. In one embodiment, the rim 734 is located close enough to the inside of the perimeter walls 708, 710, 712, 714 that water and other environmental elements do not migrate into the power supply case 700 between the base plate 702 and enclosure body 704.

In the exemplary embodiment, the base plate 702 defines a plurality of air vents 738 on plate 727 to facilitate flow of air into and out of the power supply case 700 in order to provide cooling to the power supply unit 706. Each air vent 738 defines an elongated aperture, in the form of an oval or rectangle, through the plate 727 of the base plate 702. A shroud 740 extends rearward of the plate 727, into the power supply case 700, at each air vent 738 to prevent environmental elements such as rain, snow, etc. from flowing into the power supply case 700. Each shroud 740 comprises a perimeter wall 742 extending perpendicular to the plate 727 and along the lower edge of the aperture and up along the sides of the aperture to the top of the aperture. Each shroud 740 further comprises a rear wall 744 extending parallel to the plate 727 and across the distal ends of the perimeter wall 742. In this exemplary configuration, the shrouds 740 create a path of travel for any air, rain, snow, etc. entering the power supply case 700 through the air vents 738 that requires vertical travel to clear the shroud rear wall 744. This configuration prevents most rain, snow and other unwanted environmental elements from entering the power supply case 700 while allowing air to flow into and out of the power supply case 700.

Power supply units 706 provide the power necessary to run the PCB 300, including driving the LEDs 304 that produce the images displayed on the video board 100. As is understood by persons of ordinary skill in the art of power supply units for LED video boards, the LEDs 304 are not continuously driven to provide illumination (i.e. “on”). Rather, the LEDs 304 are repeatedly turned on and turned off in cycles designed to cooperate with the frame rate of the human eye so as to reduce the amount of electricity consumed by the operation of the video board 100. Turning the LEDs 304 on and off in this manner requires power surges which are supplied by the power supply units 706. This power surging degrades power supply units like power supply unit 706 and typically causes failure sooner than if the power supply were left to keep the LEDs 304 on. As a result, it is not uncommon for power supply units 706 to fail during the lifetime of an LED video board such as video board 100. Because it is difficult to predict exactly when a power supply unit will fail, it is therefore desirable to provide for quick replacement of each power supply unit 706 such that limited down time will be experienced when failure occurs during operation.

As depicted in FIGS. 9D and 9E (as well as FIGS. 2B and 2E), the power supply 700 is mounted on the rear face 220 of the frame 202 in the exemplary embodiment of the video board 100. In one embodiment of the present video board 100, each power supply unit 706 powers a single PCB 300 and drive the LEDs 304 of a single video block 200. In other words, the video board has a 1:1 ratio of power supply units 706 to video blocks 200, as depicted in FIG. 1D. This ratio allows the video board 100 to operate with less damaging power surging on each power supply unit 706. This ratio also necessitates a greater number of power supply units 706 for a video board 100. However, the greater longevity afforded each power supply unit 706 and the ability to change a power supply unit 706 that is afforded by the power supply case 700 (discussed below) offset the costs of the additional number of power supply units 706.

In the exemplary embodiment, the power supply case 700 is depicted as mounted to the frame central internal vertical brace 212, but can be located elsewhere on the frame 202 such as, for example, the first or second internal vertical brace 214, 216. In the exemplary embodiment, the frame central internal vertical brace 212 comprises a plurality of mounting tabs 746 onto which the power supply case 700 can be releasably mounted. Four mounting tabs 746 are depicted, but other numbers of mounting tabs 746 are contemplated for the purpose of releasably mounting the power supply case 700. Each mounting tab 746 comprises an extension arm 748 extending rearward from one of the first and second channel walls 282, 284 of the central internal vertical brace 212 to a distal end where a holding finger 750 extends outward, parallel to the frame rear face 220. The holding finger 750 is a semicircle in the depicted embodiment, but other shapes are contemplated.

The plate 727 of the base plate 702 defines a plurality of mounting slots 752 to receive the mounting tabs 746 of the frame 202. The mounting slots 752 each comprise an insert aperture 754 and a retention slot 756. The holding finger 750 is larger than the retention slot 756 and configured to permit the holding finger 750 to be inserted through the plate 727 of the base plate 702 and be located inside the power supply 700. In the depicted embodiment, the insert aperture 754 is shaped as a semicircle to accommodate the semicircular shape of the holding finger 750. Other shapes of the insert aperture 754 are also contemplated. The retention slot 756 is narrower than the insert aperture 754 and configured slightly wider than the mounting tab extension arm 748, but not as wide as the mounting tab holding finger 750. In this configuration, the mounting slots 752 facilitate insertion of the mounting tab holding finger 750 through the plate 72 and into the power supply and then sliding of the mounting tab 746 with respect to the mounting slot 752 such that the extension arm 748 is located in the retention slot 756 which is too small to allow the mounting tab holding finger 750 to pass, thus securing the mounting tab 746 to the plate 727 which, in turn, secures an assembled power supply 700 to the frame 202. In this configuration, mounting of the power supply 700 to the frame 202 is simple: the power supply 700 is associated with the frame 202, each insert aperture 754 is aligned with an associated one of the holding fingers 750, the power supply 700 is moved toward the frame 202 to pass the holding fingers 750 through the insert apertures 754, the power supply is then slid parallel to the frame rear face 220 to move the mounting tab extension arms 748 from the insert aperture 754 to the retention slot 756. When the video block 200 is installed as part of a video board 100, this parallel movement is a downward movement such that the gravitational pull on the power supply 700 keeps the frame mounting tabs 746 in the retention slot 746 of the power supply case 700 and the power supply case 700 secured to the frame 202.

A plurality of biasing tabs 758 extend from the rearward face of the base plate adjacent to the lower end of the mounting slot insert aperture 754. The biasing tabs contact the mounting tab holding finger 750 on the frame 202 when the power supply case 700 is mounted as, discussed above, and press against the mounting tab holding finger 750 to bias the power supply base plate 702 against the front side of the holding finger 750. This biasing holds the power supply case 700 stable and vibration-free with respect to the frame 202. The biasing tabs 758 each have an extension arm 760 extending outward, perpendicular, from the plate 727 and a flex arm 762 extending from the distal end of the extension arm 760, parallel to the plate 727, to a location over the retention slot 756 where the flex arm 762 is flexed rearward by the mounting tab holding finger 750 when the mounting tab extension arm 748 is in the retention slot 756. In the depicted embodiment, the portion of the flex arm 762 engaged by the mounting tab holding finger 750 is configured in a V-shape with the vertex pointed downward to engage the mounting tab holding finger 750. The proximate angled portion of this V-shape of the flex arm allows the mounting tab holding finger 750 to catch the V-shaped end of the flex arm 762 and deflect it as the power supply case 700 is slid onto the frame 202.

In the depicted embodiment, a locking tab 764 extends from the rear face wall 280 of the central internal vertical brace 212 to releasably lock the power supply 700 in place when the mounting tab extension arm 748 is in the mounting slot retention slot 756 in order to prevent the power supply 700 from sliding back to where the mounting tab holding finger 750 is located in the mounting slot insert aperture 754. The locking tab 764 comprises a flex arm 766 and a lock block 768. The locking tab flex arm 766 extends at a proximate end 770 from the rear face wall 280 of the central internal vertical brace 212 into a ventilation hole 286, running parallel with the rear face wall 280, to a distal end 772 in the ventilation hole 286. The lock block 768 extends from the distal end 772 of the flex arm 766 and forms a block extending rearward of the frame 202 adjacent to the top perimeter wall 708 of the power supply enclosure body 704 when the mounting tab extension arm 748 resides in the retention slot 756 of the power supply base plate 702. Because the lock block 768 sits adjacent to the top perimeter wall 708 of the power supply enclosure body 704, the power supply 700 cannot be slid upward with respect to the frame 202 so as to bring the holding fingers 750 into alignment with the insert aperture 754 to allow the power supply 700 to be separated from the frame 202. The lock block 768 also provides for ready location for a finger to push down on, flexing the flex arm 766 sufficiently to move the lock block 768 out of the was so as to allow the power supply to be slide upward past the lock block 768 to bring the insert apertures 754 into alignment with the holding fingers 750 and allow the power supply case 700 to be separated from the frame 202. Conversely, mounting of the power supply case 700 can be accomplished by: aligning the insert apertures 754 with the holding fingers 750; pressing the power supply toward the frame 202, which will cause the plate 727 to contact the lock block 768 and flex the flex arm 766 until the plate 727 can be slid; sliding the plate 727 causing extension arm 748 to reside in the retention slot 756; allowing the flex arm to snap the lock block 768 back to a position adjacent to the enclosure body top perimeter wall 708, locking the power supply 700 to the frame 202. The depicted locking tab 764 is beneficial, but not necessary.

With or without the locking tab 764, the power supply case 700 can be quickly mounted to the frame 202 or removed from the frame 202 as desired. This facilitates quick replacement of a power supply unit 706 upon, for example, failure of a power supply unit 706 during use of the video board 100.

Although the mounting tabs 746 and locking tab 764 are depicted and described in the exemplary embodiment as located on the frame central internal vertical brace 212, they can be located elsewhere on the frame 202, such as on the first or second side internal vertical brace 214, 216. Alternatively, the mounting tabs 746 and locking tab 764 can be located on the cabinet 102, such as on the vertical or horizontal beams 132, 134 or on the first or second side perimeter flanges 108, 110.

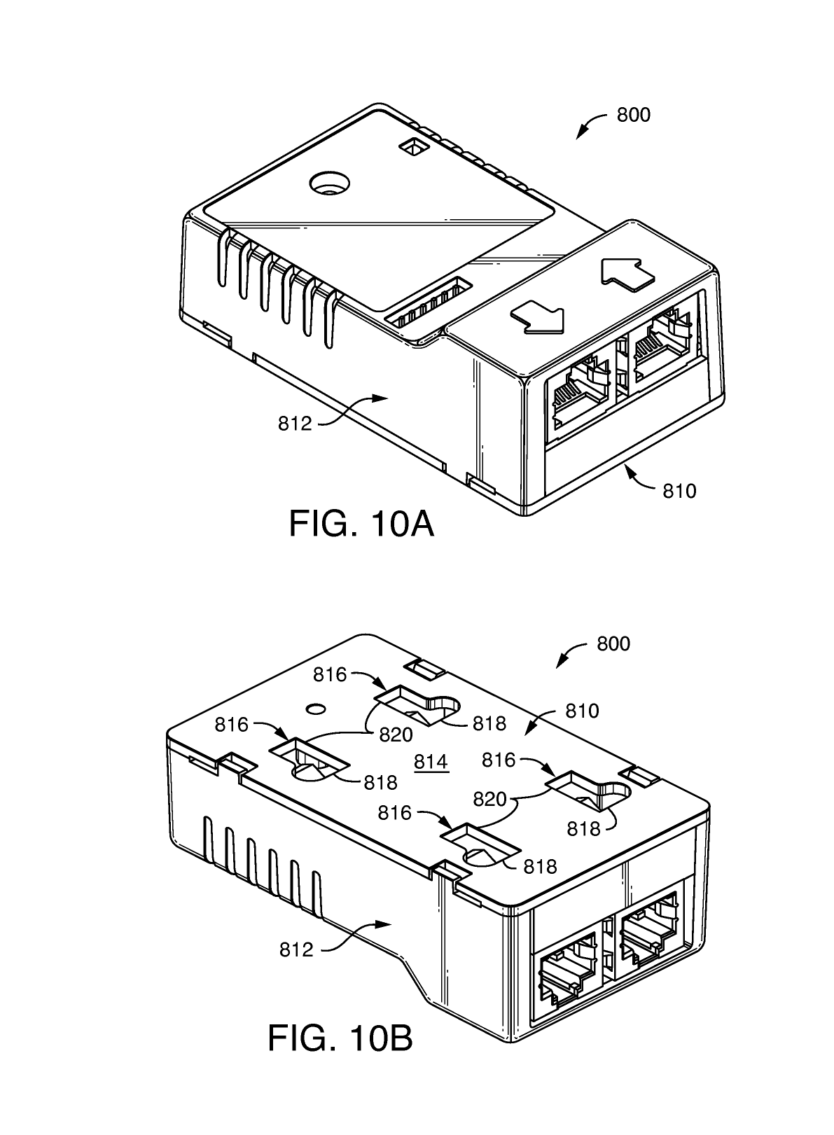

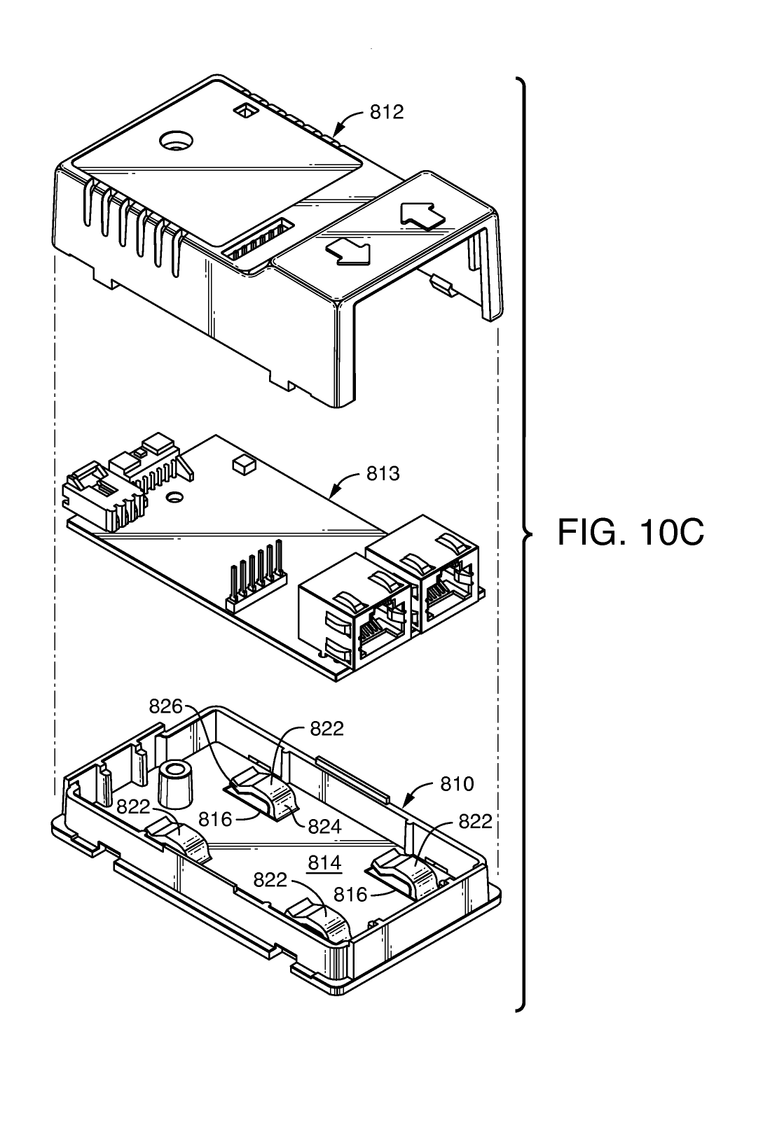

As depicted in FIGS. 2B, 2E, and 10A-10C, the matrix controller case 800 is mounted on the rear face 220 of the frame 202 in the exemplary embodiment of the video board 100. In the exemplary embodiment, the matrix controller case 800 is mounted to the frame first side internal vertical brace 214, but can be located elsewhere on the frame 202 such as, for example, the second internal vertical brace 216 or the central internal vertical brace 212. In this exemplary embodiment, the first side internal vertical brace 214 comprises a plurality of mounting tabs 802 onto which the matrix controller case 800 can be releasably mounted. Four mounting tabs 802 are depicted, but other numbers of mounting tabs 802 are contemplated for the purpose of releasably mounting the matrix controller case 800. Each mounting tab 802 comprises an extension arm 804 extending rearward from one of the first and second brace walls 288, 290 of the first side internal vertical brace 212 to a distal end where a holding finger 806 extends outward, parallel to the frame rear face 220. The holding finger 806 is a semicircle in the depicted embodiment, but other shapes are contemplated. In the depicted embodiment, each holding finger 806 comprises a horizontal groove 808 in its rear face.

The matrix controller case 800 comprises a base plate 810 and an enclosure body 812 to enclose matrix controller electronics 813. The base plate 810 comprises a plate 814 that defines a plurality of mounting slots 816 to receive the mounting tabs 802 on the frame first side internal vertical brace 212. The mounting slots 816 each comprise an insert aperture 818 and a retention slot 820. The holding finger 806 is larger than the retention slot 820 and configured to permit the holding finger 806 to be inserted through the plate 814 of the base plate 810 and be located inside the matrix controller case 800. In the depicted embodiment, the insert aperture 818 is shaped as a semicircle to accommodate the semicircular shape of the holding finger 806. Other shapes of the insert aperture 818 are also contemplated. The retention slot 820 is narrower than the insert aperture 818 and configured slightly wider than the mounting tab extension arm 804, but not as wide as the mounting tab holding finger 806. In this configuration, the mounting slots 816 facilitate insertion of the mounting tab holding finger 806 through the plate 814 and into the matrix controller case 800 and then sliding of the mounting tab 802 with respect to the mounting slot 816 such that the extension arm 804 is located in the retention slot 820 which is too small to allow the mounting tab holding finger 806 to pass, thus securing the mounting tab 802 to the plate 814 which, in turn, secures an assembled matrix controller case 800 to the frame 202. In this configuration, mounting of the matrix controller case 800 to the frame 202 is simple: the matrix controller case 800 is associated with the frame 202, each insert aperture 818 is aligned with an associated one of the holding fingers 806, the matrix controller case 800 is moved toward the frame 202 to pass the holding fingers 806 through the insert apertures 818, the matrix controller case 800 is then slid parallel to the frame rear face 220 to move the mounting tab extension arms 804 from the insert aperture 818 to the retention slot 820. When the video block 200 is installed in a video board 100, this parallel movement is a downward movement such that the gravitational pull on the matrix controller case 800 keeps the frame mounting tabs 802 in the retention slot 820 of the matrix controller case 800 and matrix controller case 800 secured to the frame 202.

A plurality of biasing tabs 822 extend from the rearward face of the base plate adjacent to the lower end of the mounting slot insert aperture 818. The biasing tabs 822 contact the mounting tab holding finger 806 on the frame 202 when the matrix controller case 800 is mounted, as discussed above, and press against the mounting tab holding finger 806 to bias the matrix controller base plate 810 against the front side of the holding finger 806. This biasing holds the matrix controller case 800 stable and vibration-free with respect to the frame 202. The biasing tabs 822 each have an extension arm 824 extending outward, perpendicular, from the plate 814 and a flex arm 826 extending from the distal end of the extension arm 824, parallel to the plate 814, to a location over the retention slot 820 where the flex arm 826 is flexed rearward by the mounting tab holding finger 806 when the mounting tab extension arm 804 is in the retention slot 820. In the depicted embodiment, the portion of the flex arm 826 engaged by the mounting tab holding finger 806 is configured in a V-shape with the vertex pointed downward to engage the mounting tab holding finger 806 in the horizontal groove 808. The proximate angled portion of this V-shape of the flex arm allows the mounting tab holding finger 806 to catch the V-shaped end of the flex arm 826 and deflect it as the matrix controller case 800 is slid onto the frame 202. When the vertex of the V-shaped portion of the holding finger 806 resides in the groove 808 of the mounting tab 802, it holds the matrix controller case 800 in place with respect to the frame 202 under normal circumstances when a user is not attempting to slide the matrix controller case 800 off of the frame 202. A user can, however, with a little force, slide the matrix controller case 800 along the frame 202, forcing the vertex of the V-shaped portion of the holding finger 806 out of the horizontal groove 808.

In the depicted embodiment, the second side internal vertical brace 216 also comprises mounting tabs. In this embodiment, the matrix controller case 800 can be mounted on either the first or second side internal vertical brace 214, 216.

In an alternative embodiment, the first side internal vertical brace 241 could comprise a locking tab such as a locking tab 764 to releasably lock the matrix controller case 800 in place in the same way that locking tab 764 locks the power supply case 700 in place, as discussed above. Such a locking tab could be used instead of, or in addition to, the horizontal groove 808 discussed above. With or without such a locking tab, the matrix controller case 800 can be quickly mounted to the frame 202 or removed from the frame 202 as desired. This facilitates quick assembly and replacement of the matrix controller electronics 813 as needed.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but are to be accorded the full scope consistent with the claim language, wherein reference to an element in the singular is not intended to mean “one and only one” unless specifically so stated, but rather “one or more.” Headings and subheadings, if any, are used for convenience only and do not limit the scope of the disclosure.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as “an aspect” or “an embodiment” may refer to one or more aspects or embodiments, and vice versa, such phrases do not imply that such aspect(s) or embodiment(s) is essential to the subject technology or that such aspect(s) or embodiment(s) apply to all configurations of the subject technology. A disclosure relating to an aspect or embodiment may apply to all aspects or embodiments, or one or more aspects or embodiments. An aspect or embodiment may provide one or more examples.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

Various modifications may be made to the examples described in the foregoing, and any related teachings may be applied in numerous applications, only some of which have been described herein. It is intended by the following claims to claim any and all applications, modifications and variations that fall within the true scope of the present teachings.

What is claimed is:

1. A display comprising:
a plurality of modular display blocks, one or more of the modular display blocks comprising a frame defining a perimeter, a circuit board associated with the frame, a plurality of light emitting diodes associated with the circuit board, and a louver;
the louver comprising a panel defining a perimeter and one or more apertures, the one or more panel apertures associated with one or more of the plurality of light emitting diodes; and
the louver further comprising a flange extending from the panel perimeter to the frame perimeter and attaching the louver to the frame.

2. The display of claim 1, the louver flange further comprising one or more barbs that facilitate a releasable snap-fit attachment of the louver to the frame.

3. The display of claim 1, the frame further comprising a flange defining the perimeter of the frame and the louver flange further comprising one or more barbs that facilitate a releasable snap-fit attachment of the louver to the frame flange.

4. The display of claim 1, the frame further comprising a flange defining the perimeter of the frame and the louver flange further comprising one or more barbs that facilitate a releasable snap-fit attachment of the louver to the frame flange when the barb resides in a recess on the frame perimeter flange.

5. The display of claim 1 wherein the louver panel defines a plane and the louver flange extends perpendicular to the plane.

6. The display of claim 1, one or more boss extends from the louver panel to facilitate attachment to the frame.

7. The display of claim 1, one or more boss extends from the louver panel through an aperture defined in the circuit board to facilitate attachment to the frame.

8. The display of claim 1, one or more barbs extend from the louver panel through an aperture defined in the circuit board to facilitate snap-fit attachment to the frame.

9. The display of claim 1 the light emitting diodes each comprising leg terminals and the leg terminals are mounted to the circuit board and the display further comprises a pool of potting surrounding the leg terminals of at least one light emitting diode.

10. The display of claim 1, the louver further comprising ribs extending from the louver panel to manage ambient light.

11. A display comprising:
a frame, a circuit board associated with the frame, a plurality of light emitting diodes comprising leg terminals electrically connected to the circuit board, and a louver;
the louver comprising a panel defining one or more apertures, the a panel aperture associated with a group of one or more of the plurality of light emitting diodes; and
a potting pool covering the leg terminals of only those light emitting diodes in the group.

12. The display of claim 11 further comprising a gasket between the louver and the circuit board, the gasket defining an aperture circumscribing the group of light emitting diodes.

13. The display of claim 11 further comprising a gasket between the louver and the circuit board, the gasket defining an aperture circumscribing the group of light emitting diodes and the aperture defining a perimeter of the potting pool.

14. The display of claim 11 further comprising a gasket between the louver and the circuit board, the gasket defining an aperture circumscribing the group of light emitting diodes and the gasket comprising a web and a rib extending from the web, the rib circumscribing the group of light emitting diodes.

15. The display of claim 11 further comprising a gasket between the louver and the circuit board, the gasket defining an aperture circumscribing the group of light emitting diodes and the gasket comprising a web and a rib extending from the web, the rib circumscribing the group of light emitting diodes and defining a perimeter of the potting pool.

16. The display of claim 11, the louver panel further defining a perimeter and the louver further comprising a flange extending from the panel perimeter comprising one or more barbs that facilitate a snap-fit connection to the louver to the frame.

17. The display of claim 11, the louver panel defining multiple apertures, each associated with two light emitting diodes.

18. The display of claim 11, the louver panel defining a plurality of potting pools, one potting pool covering the terminal legs of two light emitting diodes and a second potting pool covering the terminal legs of more or less than two light emitting diodes.

19. The display of claim 11, one or more boss extends from the louver panel to facilitate attachment to the frame.

20. The display of claim 11, one or more boss extends from the louver panel through an aperture defined in the circuit board to facilitate attachment to the frame.

21. The display of claim 11, one or more barbs extend from the louver panel through an aperture defined in the circuit board to facilitate snap-fit attachment to the frame.

22. The display of claim 11, the circuit board defining a first side, on which the light emitting diodes are attached, and a second side comprising electrical components, the display further comprising potting on the second side of the circuit board covering connections of one or more of the electrical components to the circuit board.

23. The display of claim 11, the circuit board defining a first side, on which the light emitting diodes are attached, and a second side comprising electrical components, the display further comprising potting covering one or more of the electrical components on the second side.

24. The display of claim 11, the circuit board defining a first side, on which the light emitting diodes are attached, and a second side comprising electrical components, the display further comprising potting on the second side of the circuit board covering connections of each of the electrical components to the circuit board.

25. The display of claim 11 comprised of a plurality of modular display blocks, the frame constituting an element of one of the modular display blocks.

26. A display comprising:
a frame, a circuit board associated with the frame, and a plurality of light emitting diodes electrically connected to the circuit board, and a power supply case housing a power supply unit for providing electrical power to the circuit board and light emitting diodes;
the frame comprising a mounting tab extending from the frame, the mounting tab comprising a proximate end extending from the frame and a distal end being wider than the proximate end;
the power supply case comprising an enclosure body and a base plate, the base plate defining a mounting slot having an insert aperture having a width sized to allow the frame mounting tab distal end to pass through the base plate and a retention slot having a width sized to prevent the frame mounting tab distal end from passing through the base plate wherein the distal end of the mounting tab can be passed through the insert aperture and the power supply case moved to slide the mounting tab into the retention slot.

27. The display of claim 26, the frame comprising a plurality of mounting tabs and the power supply case base plate having a plurality of mounting slots.

28. The display of claim 26, the frame comprising four mounting tabs and the power supply case base plate having four mounting slots.

29. The display of claim 26, the display and the power supply case oriented such that the gravitational pull on the power supply tends to keep the mounting tab in the retention slot of the mounting slot.

30. The display of claim 26, the proximate end of the mounting tab comprising an extension arm extending perpendicular to the frame and the distal end of the mounting tab comprising a holding finger extending perpendicular to the extension arm.

31. The display of claim 26, the frame comprising a plurality of perimeter beams and internal braces extending between two or more of the perimeter beams, the mounting tab extending from one or more of the perimeter beams and internal braces.

32. The display of claim 26, the frame comprising two horizontal perimeter beams, two vertical perimeter beams connecting the ends of the horizontal perimeter beams, a central internal vertical brace extending between the two horizontal perimeter beams and first and second side internal vertical braces extending between the two horizontal perimeter beams, the mounting tab extending from one of the central internal vertical brace and the first and second side internal vertical braces.

33. The display of claim 26, further comprising tabs extending from the base plate and having a flexible arm extending to a position adjacent to the retention slot such that the flexible arm contacts the distal end of the mounting tab when the mounting tab is in the retention slot.

34. The display of claim 26 comprised of a plurality of modular display blocks, the frame constituting an element of one of the modular display blocks.
